(19) United States
(12) Patent Application Publication
(10) Pub. No.: US 2016/0137850 A1
(43) Pub. Date: May 19, 2016

(54) A GLAZING

(71) Applicant: PILKINGTON GROUP LIMITED, LATHOM (GB)

(72) Inventors: JOHN ANDREW RIDEALGH, CUDDINGTON (GB); SIMON JAMES HURST, RUNCORN (GB); SIMON JOHN SLADE, ORMSKIRK (GB)

(73) Assignee: PILKINGTON GROUP LIMITED, LATHOM (GB)

(21) Appl. No.: 14/392,110

(22) PCT Filed: May 22, 2014
(86) PCT No.: PCT/GB2014/051569

§ 371 Date: Nov. 23, 2015

(30) Foreign Application Priority Data
May 24, 2013 (GB) 1309386.9

(51) Int. Cl. C09D 5/00; C08K 3/22; C08K 3/36; C09D 5/33

(52) U.S. Cl. CPC C09D 5/006; C09D 5/004; C08K 3/22; C08K 3/36; C08K 2003/2241; C08K 2003/2231

(57) ABSTRACT

The invention provides a glazing for minimising or preventing bird collisions with windows or other glazings. The glazing comprises at least one substrate, an antireflection coating, and a UV reflectance coating. The antireflection coating is between the UV reflectance coating and the substrate. The UV reflectance coating is provided in a patterned arrangement comprising a plurality of separate elements, each element being spaced apart from a neighbouring element.

The present invention relates to a glazing for minimising or preventing bird collisions with windows or other glazings. The invention further relates to a method of manufacturing such a glazing.

Bird deaths due to window strikes represent one of the greatest threats to avian mortality next to habitat destruction. Due to the reflective and transparent characteristics of glass, the glass is not perceived as a barrier to the bird. The bird does not recognize that reflections of, for example, the sky, other buildings, vegetation and even open space, are false. As a result, the bird flies into the glass. Typically, the glass is a glazing in a building, for example, a window, but could equally be a glass balcony, a glazed door, etc.

Many millions of birds die each year from collisions with glass on buildings. While songbirds are most at risk from collisions with glass, nearly 300 species have been reported as collision victims, including hummingbirds, woodpeckers, kingfishers, waders and birds of prey. It is likely that these numbers will grow as advances in glass technology and production make it possible to construct buildings with all-glass curtain walls, in addition to the general increase in the amount of glass being used in architecture.

The reduction of bird strikes can be achieved in a number of ways. A common approach involves creating a visual signal that alerts the birds to the presence of the glass. Known techniques include the use of fritting, i.e. the placement of ceramic lines or dots on glass, the use of screens, latticework, or grilles. More recently however, it has been shown that the use of ultraviolet (UV) patterns on glass may help birds to detect the presence of the glass.

Many families of birds are tetrachromatic, possessing four types of cone cells each with a distinctive maximal absorption peak. In some bird families, the maximal absorption peak of the cone cell responsible for the shortest wavelength extends to the UV range, making them UV-sensitive. As such, many birds are able to see into the UV spectrum, in particular in the range 300 to 400 nm, a range largely invisible to humans. A UV reflective coated glass for preventing bird collisions is known under the registered trade mark Ornilux Mikad®. The glass has a UV patterned coating which is visible to birds but substantially invisible to the human eye. Disadvantageously, such glazing relies only on a UV-reflective coating and it is believed that in order to be effective, UV patterns need to have a strong contrast.

It is an object of the present invention to provide an improved glazing for minimising or preventing bird collisions with windows.

According to an aspect of the present invention there is provided a glazing for minimising or preventing bird collisions with windows or other glazings, the glazing comprising at least one substrate, an antireflection coating, and a UV reflectance coating, the antireflection coating being between the UV reflectance coating and the substrate, characterised in that the UV reflectance coating is provided in a patterned arrangement comprising a plurality of separate elements, each element being spaced apart from a neighbouring element.

The elements are not linked or touching one another i.e. they are not interconnected. Advantageously, due to this arrangement, the manufacturing of the glazing is simplified as the glazing can be readily masked into separate areas when being coated.

Preferably, the antireflection coating is provided adjacent the UV reflectance coating. Preferably, the antireflection coating is provided adjacent the substrate.

Preferably the elements comprise a plurality of stripes. Preferably, the stripes are arranged parallel to a longitudinal axis of said substrate. The elements may comprise a plurality of dots. Preferably, the elements, preferably the stripes and/or dots are equidistantly spaced apart from one another. The stripes and/or dots may be randomly spaced.

Preferably, the patterned arrangement is a regular pattern. Preferably, the patterned arrangement has at least one line of symmetry. Preferably, the line of symmetry is perpendicular to the longitudinal axis of the glazing. Preferably, the patterned arrangement comprises a repeating pattern. Preferably, the UV reflectance coating covers at least 20% of the subjacent surface. Most preferably, said coating covers at least 25% of the subjacent surface.

Preferably, a plurality of substantially 2.5 cm wide UV-reflecting stripes of said reflectance coating are provided, preferably oriented parallel to a longitudinal axis of the at least one substrate. Preferably, said stripes are separated by substantially 5 cm, most preferably 7.5 cm, antireflection coating stripes, said antireflection coating having a low UV reflectance. Preferably, the antireflection stripes are oriented parallel to a longitudinal axis of the at least one substrate.

In a most preferred arrangement, a plurality of substantially 2.5 cm wide UV-reflecting stripes are deposited on top of an antireflection coating, preferably having a 10 cm pitch. The antireflection coating thus forms 7.5 cm antireflection stripes between each pair of 2.5 cm wide UV-reflecting stripes. Advantageously, the arrangement provides an enhanced contrast over the whole visible range but with an optimised contrast in the UV range.

The UV reflectance coating may be provided as substantially 5 cm wide UV-reflecting stripes oriented parallel to a longitudinal axis of the at least one substrate, and preferably separated by substantially 2.5 cm antireflection coating stripes, said antireflection coating having a low UV reflectance. Preferably, the antireflection stripes are oriented parallel to a longitudinal axis of the at least one substrate.

The UV reflectance coating may be provided as a grid consisting of substantially 10 cm wide UV-reflecting columns provided parallel to a longitudinal axis of the at least one substrate, separated by substantially 2.5 cm wide antireflection coating stripes, said antireflection coating having a low UV reflectance. Preferably, the antireflection stripes are oriented parallel to a longitudinal axis of the at least one substrate. Preferably, substantially 8 cm wide UV-reflecting rows are provided perpendicular to a longitudinal axis of the at least one substrate separated by substantially 2.5 cm wide antireflection coating stripes, said antireflection coating having a low UV reflectance. Preferably, the antireflection stripes are provided perpendicular to a longitudinal axis of the at least one substrate.

Advantageously, the antireflection coating in combination with the patterned UV reflectance coating enhances bird visible UV reflected light in one area of the pattern while minimising broadband reflection (including bird-visible UV) in other areas to maximise the apparent contrast in bird vision. The effect of this is to produce a pattern that is highly visible to birds so allowing birds to avoid fatal collisions with buildings glazed with these coatings.

Preferably, the UV reflectance coating is deposited on an exterior facing surface of the substrate. This surface is often referred to as “surface #1” of the glazing.

The reflectance of glass can be reduced by the application of appropriate thin film interference coatings—“Anti-Reflection coatings”. For a broad spectral response said coatings generally fall into 3 categories as follows:
1) Single layer coatings of porous low index materials such as porous silica—which give an intermediate effective refractive index between glass and air, so reducing the reflectance at the interfaces;
2) Three layer medium/high/low refractive index combinations. An example of such a combination is Glass/46 nm ZnSnOₓ/93 nm TiO₂/75 nm SiO₂;
3) Four layer high/low/high/low refractive index combinations such as the “Optiview” coating (nominally Glass/12 nm SnOₓ/25 nm SiO₂/110 nm SnOₓ/90 nm SiO₂).

All of said categories are considered to be equally valid for the purposes of the present invention, as are other variations based on the same principles.

Preferably, the antireflection coating comprises a plurality of layers. Preferably, said layers comprise a first layer comprising tin oxide (SnO₂). Preferably, the first layer, most preferably SnO₂, has a geometric thickness of between substantially 5 nm and 100 nm, preferably between 10 nm and 50 nm, preferably between 10 nm and 20 nm, most preferably substantially 12 nm.

Preferably, a second layer is provided preferably comprising silicon dioxide (SiO₂), preferably the SiO₂ has a geometric thickness of between substantially 5 nm and 100 nm, preferably between 10 nm and 50 nm, preferably between 15 nm and 30 nm, most preferably substantially 25 nm. Most preferably, the second layer is deposited over the first layer.

Preferably, a third layer is provided preferably comprising fluorine doped tin oxide (F:SnO₂) preferably the F:SnO₂ had a geometric thickness of between substantially 5 nm and 200 nm, preferably between 50 nm and 150 nm, preferably between 100 nm and 120 nm, most preferably substantially 110 nm. Most preferably, the third layer is deposited over the second layer.

Preferably, a fourth layer is provided preferably comprising SiO₂. Preferably, the SiO₂ has a geometric thickness of between substantially 5 nm and 200 nm, preferably between 50 nm and 150 nm, preferably between 80 nm and 100 nm, most preferably substantially 90 nm. Most preferably, the fourth layer is deposited over the third layer. Such antireflection coating comprising said layers first to fourth respectively, is referred to as an Optiview coating.

Preferably, the UV reflectance coating comprises titanium dioxide (TiO₂). Preferably, said coating has a geometric thickness of between substantially 10-100 nm, more preferably from about 10-50 nm thick, and most preferably substantially 35 nm thick. Preferably, the UV reflectance coating may be a single layer of titanium oxide (TiO₂). Said coating may be deposited by magnetron sputtering, CVD, PCVD, sol-gel, or other thin film deposition techniques. Most preferably, said coating is deposited by CVD.

In a most preferred arrangement, the glazing comprises a plurality of coating layers having the sequential arrangement: substrate, preferably glass; SnO₂ having a geometric thickness of 12 nm; SiO₂ having a geometric thickness of 25 nm deposited over the SnO₂; F:SnO₂ having a geometric thickness of 110 nm deposited over the SiO₂; SiO₂ having a geometric thickness of 90 nm deposited over the F:SnO₂; UV reflectance coating comprising TiO₂ having a geometric thickness of 35 nm.

Preferably, the at least one substrate is a ply of glass, preferably a float or rolled glass. Preferably, the or each substrate of glass is a pane of extra clear glass (glass having greater than 85% visible light transmission (measured with Illuminant A) at thicknesses preferably from 2 to 20 mm, most preferably substantially 4 mm geometric thickness. The substrate may be a low-iron float glass, for example, having an iron content of 0.015% w/w or lower. The or each substrate may be a ply of tinted glass having a visible light transmission of less than 85%.

The invention is not limited to the substrate being a glazing in a building. For example, the substrate may be a door, a balcony, a spandrel. The substrate may be manufactured from polymeric material.

Preferably, the substrate comprises a surface #1 and a surface #2. Surface #1 is that surface of the substrate which faces the exterior of a building when mounted in use.

Preferably, an antireflection coating is provided on surface #1 and/or surface #2 of the substrate. Most preferably, a UV reflectance coating is provided on top of at least a part of the antireflection coating preferably when the antireflection coating is provided on surface #1. The antireflection coating may be on surface #2 with the UV reflectance coating deposited directly on top of said antireflection coating. Most preferably, the antireflection coating is provided on surface #1, and the patterned elements of the UV reflectance coating are provided directly on top of said antireflection coating. Preferably the UV reflectance coating is provided on an exterior facing surface of the glazing. Advantageously, the present arrangement provides an enhanced contrast in the glazing by combining a UV reflectance coating with an antireflection coating in the contrasting areas.

The antireflection coating may be provided on surface #2 of the substrate and the UV reflectance coating may be provided on surface #1 of the substrate.

Preferably, the glazing comprises a further coating, preferably a solar control coating, preferably a low-E coating.

According to a further aspect of the present invention there is provided a glazing for minimising or preventing bird collisions with windows or other glazings, the glazing comprising at least one substrate, an antireflection coating, and a UV reflectance coating, characterised in that the antireflection coating is provided on a different surface of the substrate to that on which the UV reflectance coating is provided. Most preferably, the UV reflectance coating is provided in a patterned arrangement comprising a plurality of separate elements.

According to a further aspect of the present invention there is provided a glazing for minimising or preventing bird collisions with windows or other glazings, the glazing comprising at least one substrate, an antireflection coating, and a UV reflectance coating, characterised in that the antireflection coating is adjacent the UV reflectance coating in a side by side configuration. Most preferably, the UV reflectance coating is provided in a patterned arrangement comprising a plurality of separate elements. The UV reflectance coating may be provided as a plurality of UV reflectance stripes on the substrate. Each said stripe preferably lies adjacent an antireflection stripe.

In a further aspect the invention provides an insulated glazing unit for minimising or preventing bird collisions with windows or other glazings, comprising a first sheet of glazing material, a second sheet of glazing material, an antireflection coating, and a UV reflectance coating, characterised in that the antireflection coating is between the UV reflectance coating and either the first and/or second sheet of glazing material. Most preferably, the UV reflectance coating is provided in a patterned arrangement comprising a plurality of separate elements.

Preferably, a space is provided between the first sheet of glazing material and the second sheet of glazing material, wherein the first sheet of glazing material has a first surface (surface #1) and an opposing second surface (surface #2), the second surface of the first sheet of glazing material facing the space. The second sheet of glazing material has a third surface (surface #3) and an opposing fourth surface (surface #4), the third surface of the second sheet of glazing material facing the space. In use, surface #1 faces the exterior of a building.

Preferably, the antireflection coating is provided on the first surface of the unit. Preferably, a second antireflection coating is provided on the unit, preferably on the second surface. Most preferably, the UV reflectance coating is provided on top of the antireflection coating on the first surface and/or the second surface. The second antireflection coating may be provided on a fourth surface of the unit.

In a further aspect the invention provides an insulated glazing unit for minimising or preventing bird collisions with windows or other glazings, comprising a first sheet of glazing material, a second sheet of glazing material, an antireflection coating, and a UV reflectance coating, characterised in that the antireflection coating is provided on a surface of the first and/or second sheet different to that on which the UV reflectance coating is provided. Most preferably, the UV reflectance coating is provided in a patterned arrangement comprising a plurality of separate elements.

Preferably, a further antireflection coating is provided on surface #1 and/or surface #2 and/or surface #3 and/or surface #4. Preferably, a further UV reflectance coating is provided on surface #1 and/or surface #2 and/or surface #3 and/or surface #4.

In a further aspect the invention provides an insulated glazing unit for minimising or preventing bird collisions with windows or other glazings, comprising a first sheet of glazing material, a second sheet of glazing material, a third sheet of glazing material, at least one antireflection coating, and at least one UV reflectance coating, characterised in that said antireflection coating is between the UV reflectance coating and either the first and/or second sheet, and/or the third sheet of glazing material. Most preferably, the UV reflectance coating is provided in a patterned arrangement comprising a plurality of separate elements.

Preferably, the first sheet of glazing material has a first surface (surface #1) and an opposing second surface (surface #2), the second sheet of glazing material has a third surface (surface #3) and an opposing fourth surface (surface #4), and the third sheet of glazing material has a fifth surface (surface #5) and an opposing sixth surface (surface #6). In use in a building glazing, surface #1 faces the exterior of a building and surface #6 faces the interior of a building.

Preferably, an antireflection coating is provided on surface #1. The or a further antireflection coating may be provided on surface #2 and/or surface #3 and/or surface #4 and/or surface #5 and/or surface #6. Most preferably, a UV reflectance coating is provided on surface #1, preferably being deposited directly over the antireflection coating. The or a further UV reflectance coating may be provided on surface #2 and/or surface #3 and/or surface #4 and/or surface #5 and/or surface #6.

Preferably, at least one solar control coating or low E coating is provided on surface #2 and/or surface #3 and/or surface #4 and/or surface #5 and/or surface #6.

Preferably, the or each said UV reflectance coating comprises titanium dioxide (TiO₂). Preferably, said coating has a geometric thickness of between substantially 10-100 nm, more preferably from about 10-50 nm thick, and most preferably 35 nm thick. Preferably, the UV reflectance coating may be a single layer of titanium oxide (TiO₂). Said coating may be deposited by magnetron sputtering, CVD, PCVD, sol-gel, or other thin film deposition techniques. Most preferably, said coating is deposited by CVD. Preferably, the or each antireflection coating comprises a plurality of layers comprising: SnO₂ having a geometric thickness of 12 nm; SiO₂ having a geometric thickness of 25 nm deposited over the SnO₂; F:SnO₂ having a geometric thickness of 110 nm deposited over the SiO₂; SiO₂ having a geometric thickness of 90 nm deposited over the F:SnO₂.

Most preferably, the or each UV reflectance coating comprising TiO₂ having a geometric thickness of 35 nm is deposited over the SiO₂.

In a further aspect, the invention provides a method of manufacturing a glazing for minimising or preventing bird collisions with windows or other glazings; the method comprising the following steps:
a) Providing at least one substrate;
b) Depositing at least one antireflection coating on a surface of the substrate;
c) Depositing at least one UV reflectance coating in a patterned arrangement over the or each antireflection coating.

Most preferably, the UV reflectance coating comprises a plurality of separate elements, preferably each element being separate from a neighbouring element.

Preferably, the UV reflectance coating comprises TiO₂. Preferably, the antireflection coating comprises SiO₂.

Preferably, step (b) is carried out using a chemical vapour deposition process. Preferably, step (c) is carried out using a sputtering process, preferably by shadow masking sputtered titania. The or each process may be carried out by magnetron sputtering, PCVD, sol-gel, localised deposition, or other thin film deposition techniques. The UV reflectance coating may be deposited by a sol gel process.

In a further aspect, the invention provides a use of a glazing or glazing unit as hereinbefore described, as an anti-collision bird safe glazing.

All of the features described herein may be combined with any one of the above aspects, in any combination.

An embodiment of the invention will now be described, by way of example only, with reference to the accompanying drawings, wherein:

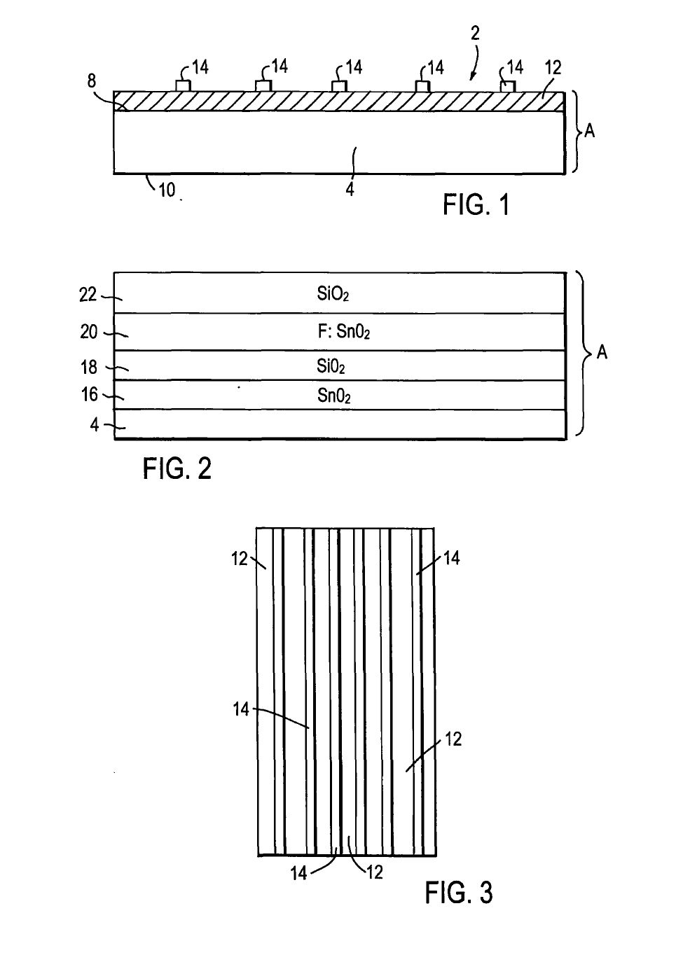

FIG. 1 shows a schematic sectional view of a glazing according to the present invention;

FIG. 2 shows a schematic sectional view of a part of a glazing according to the present invention;

FIG. 3 shows a plan view of a glazing according to the present invention;

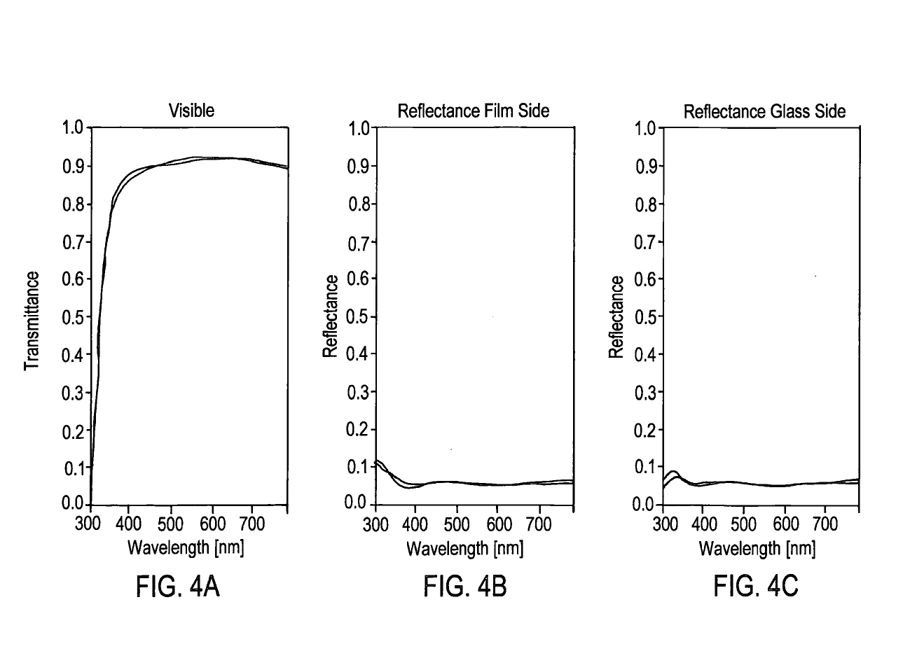

FIG. 4 shows a transmittance and reflectance graphs of an optical model fit for a 4 mm clear float substrate having an Optiview coating on a first surface;

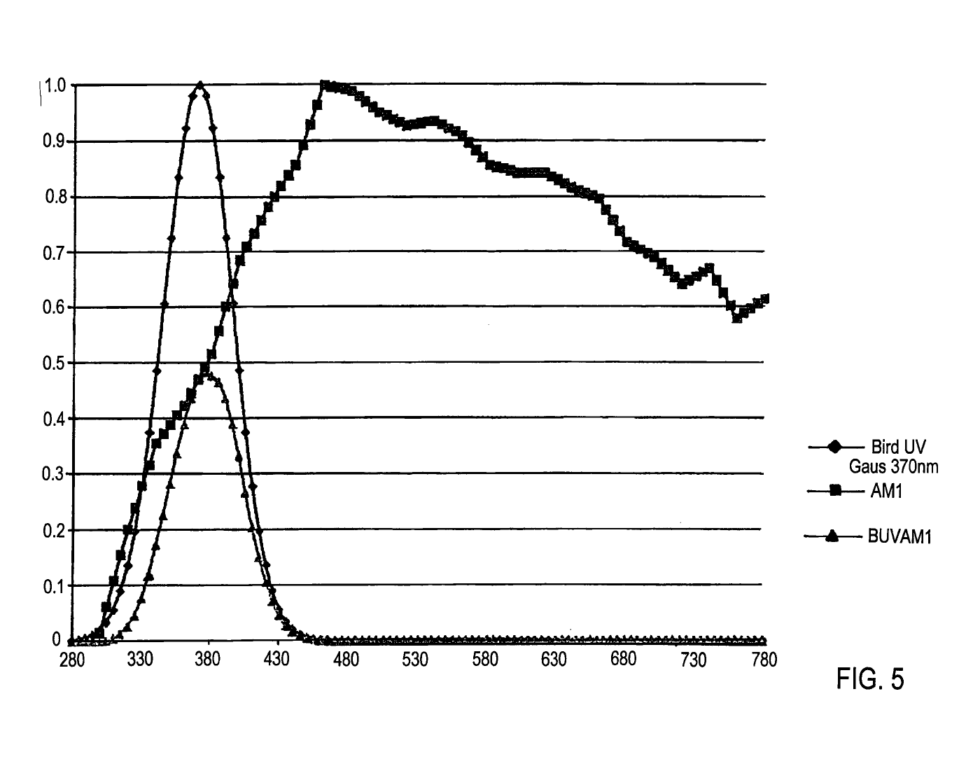

FIG. 5 shows a derivation of BUVAM1 curve for different glazing;

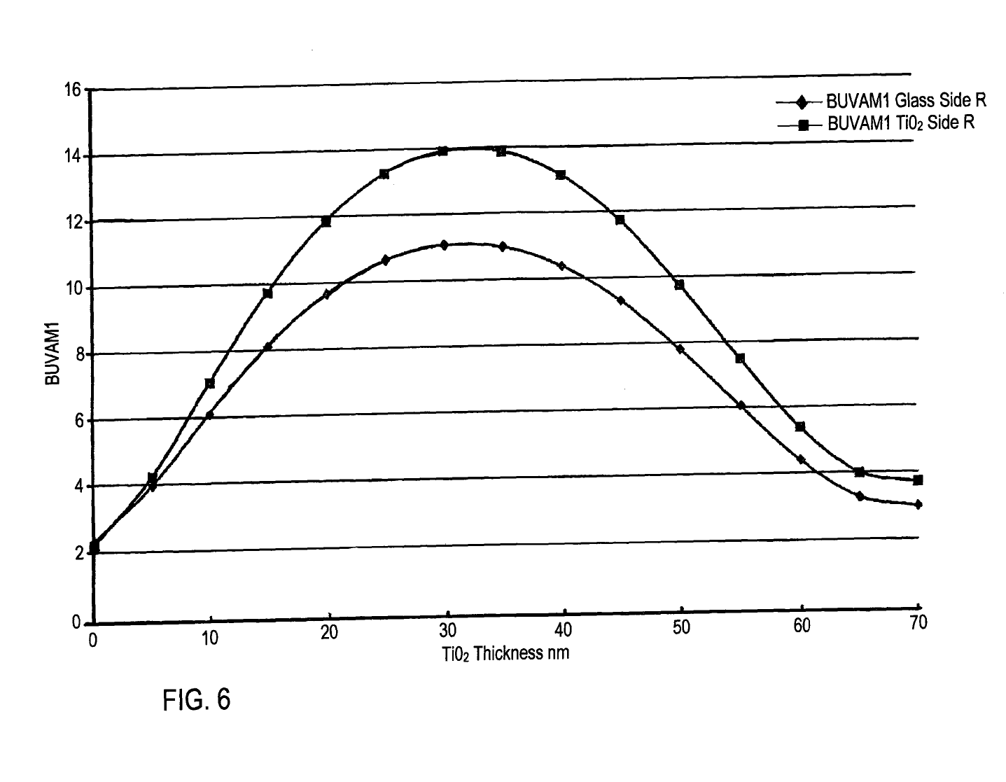

FIG. 6 shows a graph of variation in BUVAM1 with TiO2 thickness in relation to the glazing of FIG. 1;

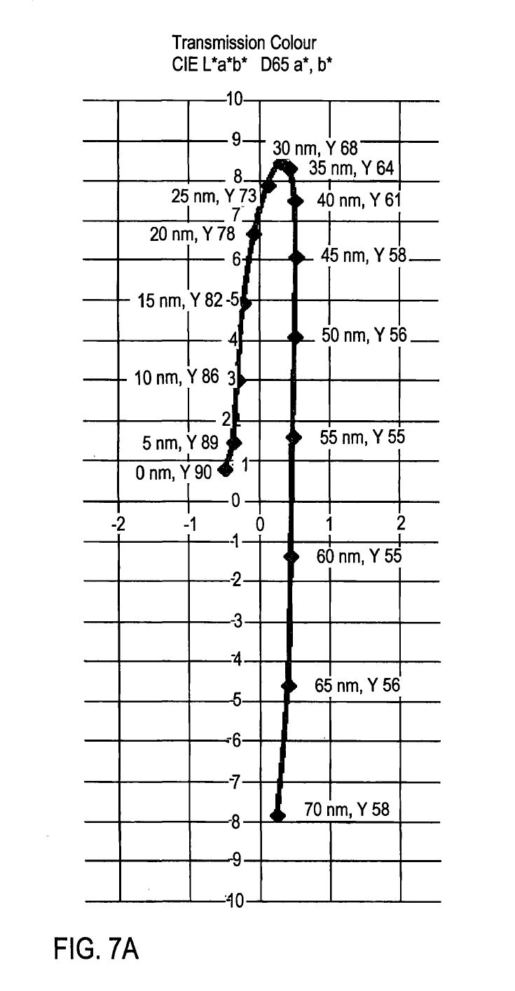

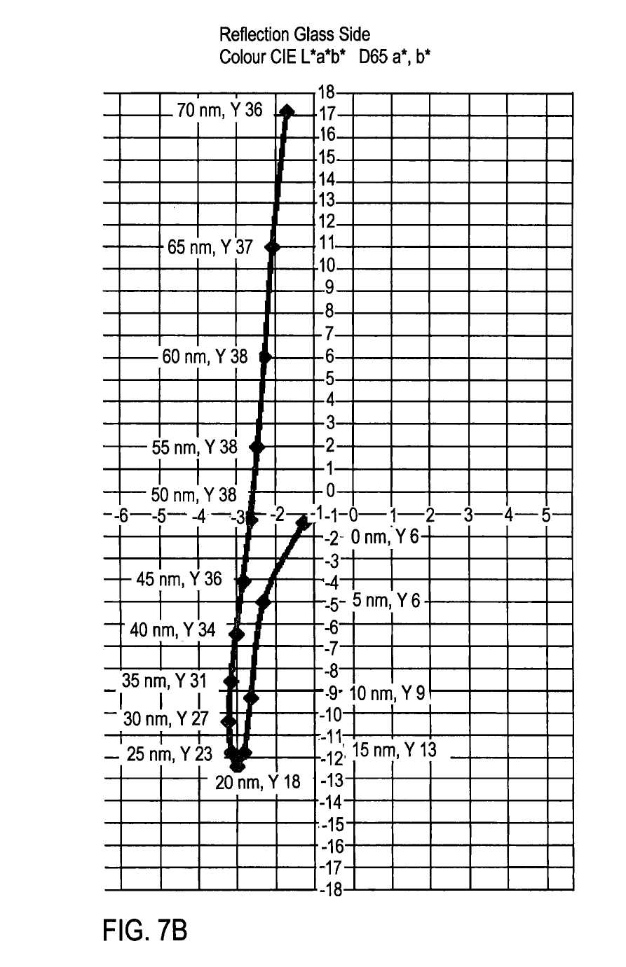

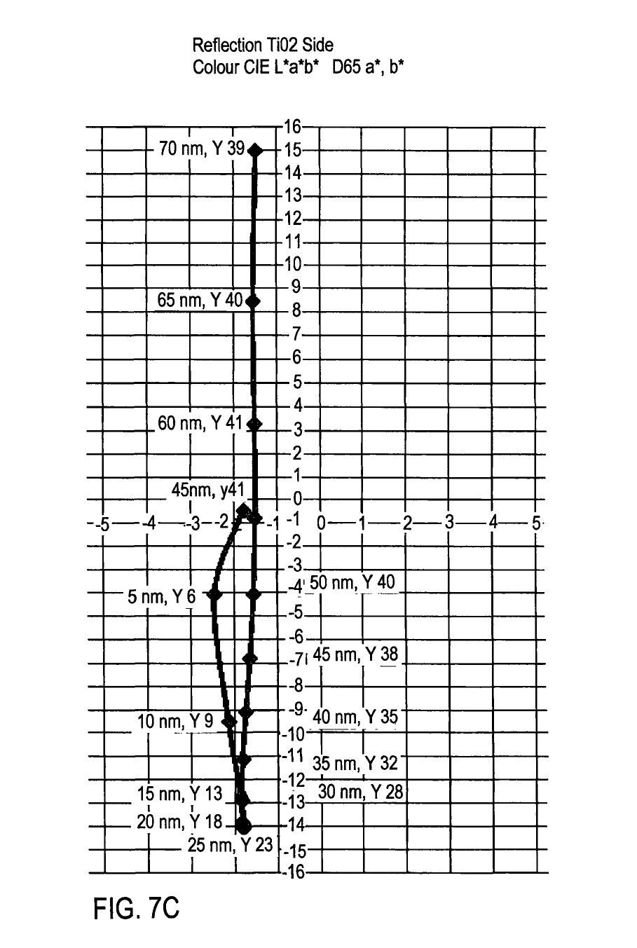

FIG. 7 shows visible colour attribute curves of the glazing of FIG. 1;

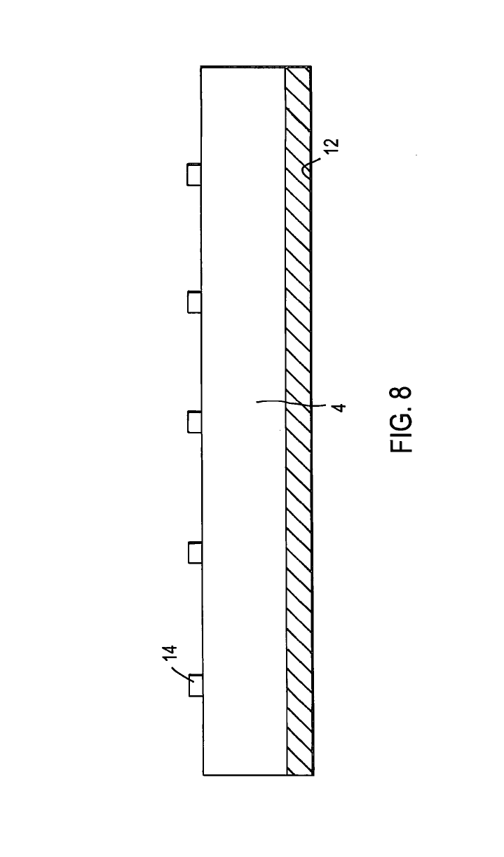

FIG. 8 shows a schematic sectional view of an embodiment of a glazing according to the present invention;

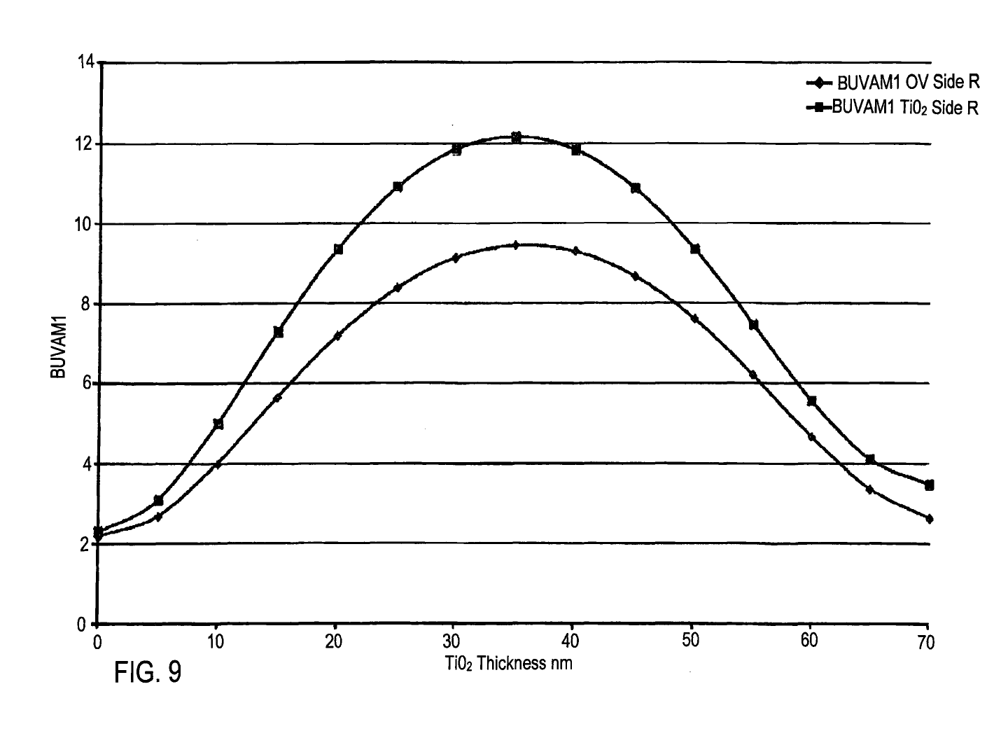

FIG. 9 shows a graph of variation in BUVAM1 with TiO2 thickness in relation to the glazing of FIG. 8;

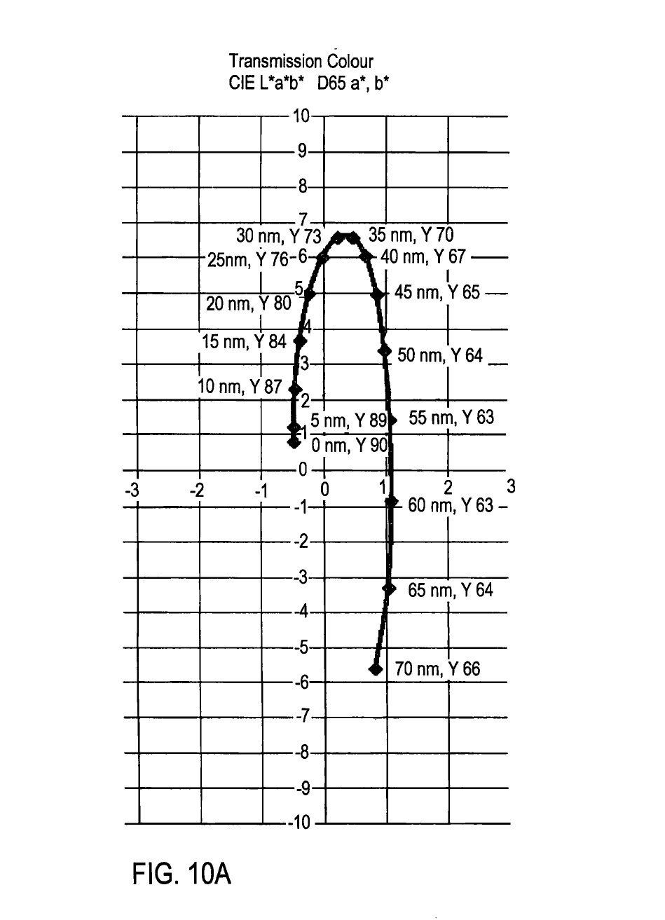

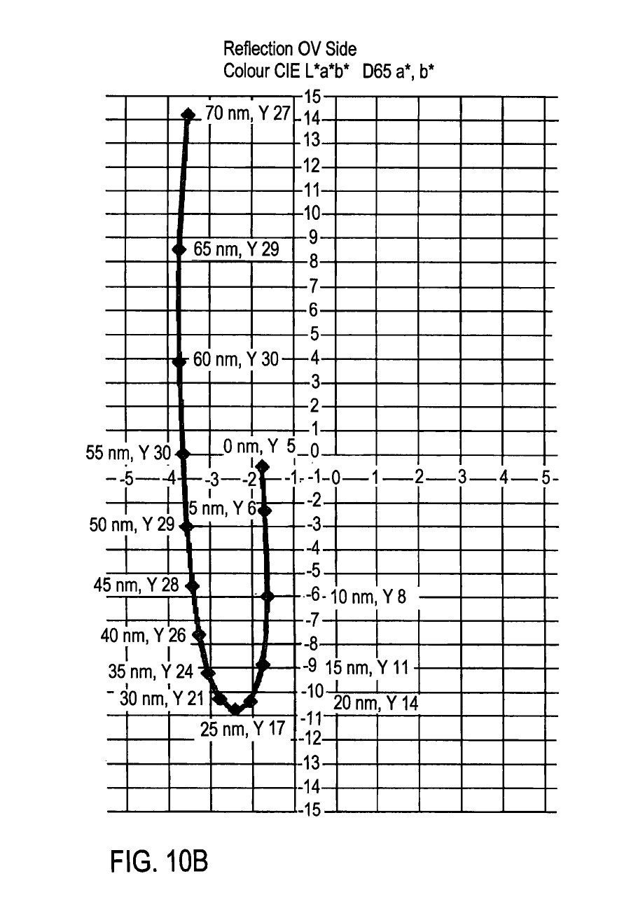

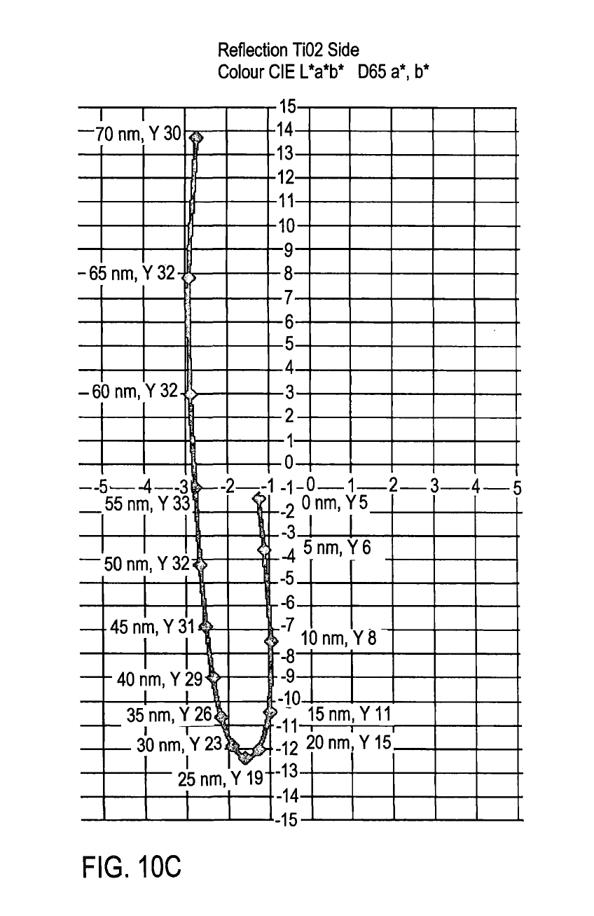

FIG. 10 shows visible colour attribute curves of the glazing of FIG. 8;

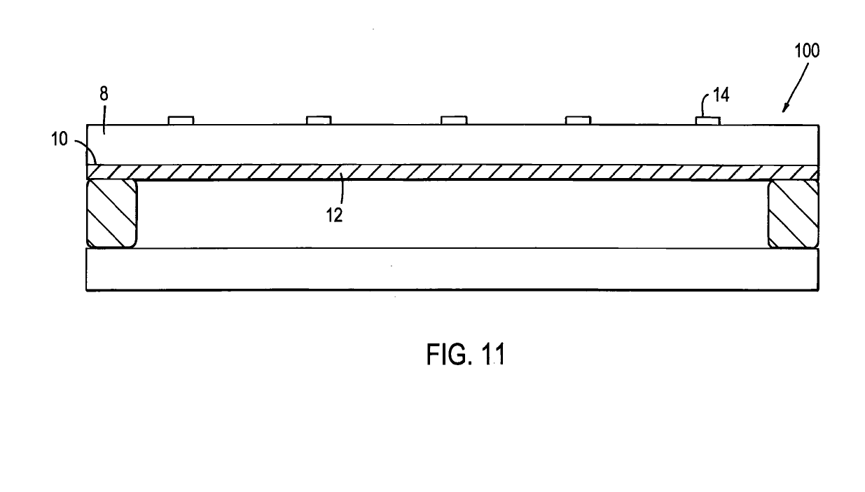

FIG. 11 shows a schematic sectional view of an embodiment of a glazing according to the present invention;

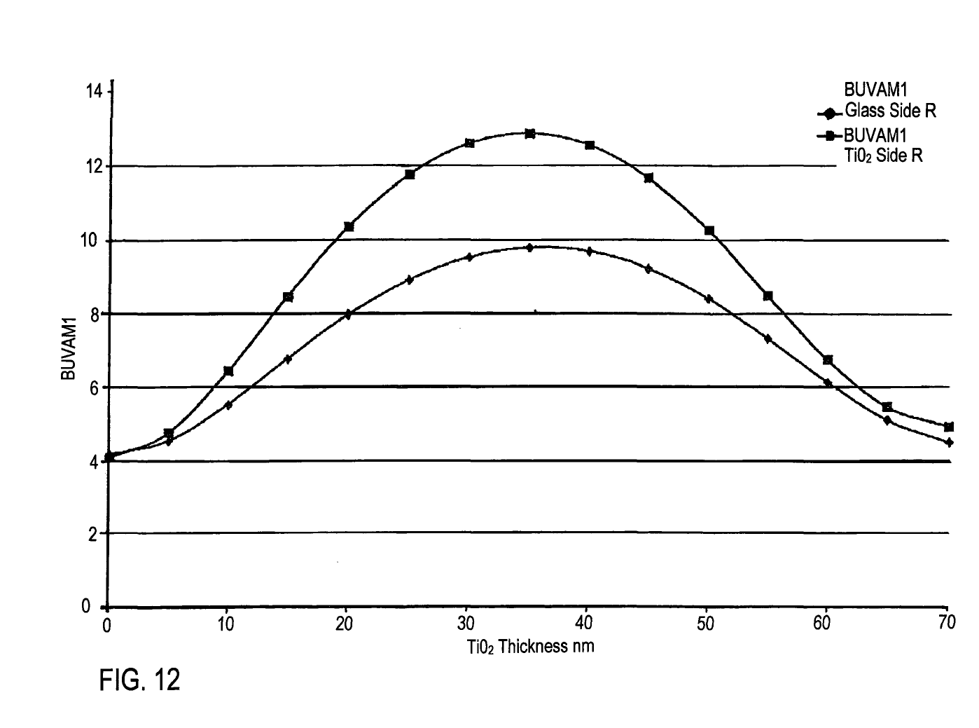

FIG. 12 shows a graph of variation in BUVAM1 with TiO2 thickness in relation to the glazing of FIG. 11;

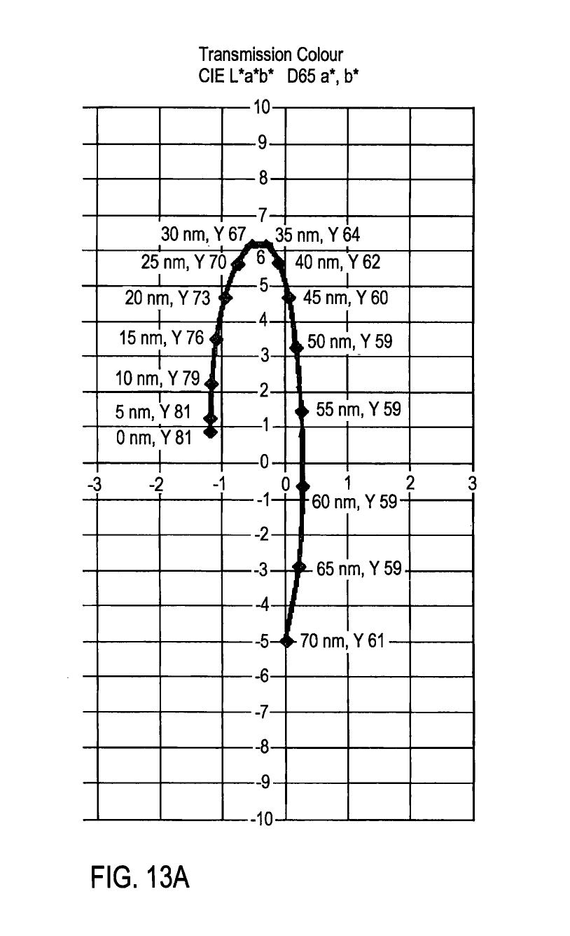

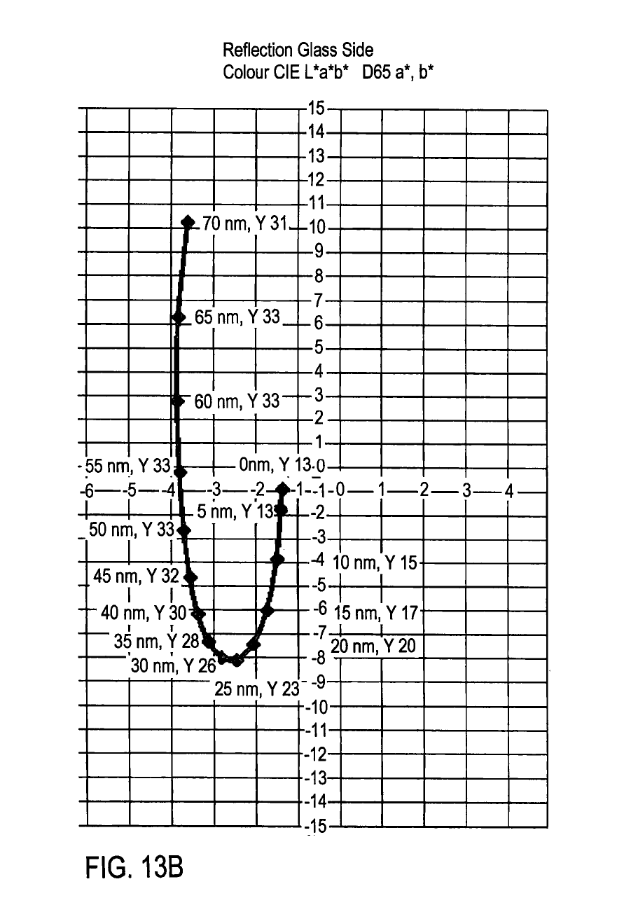

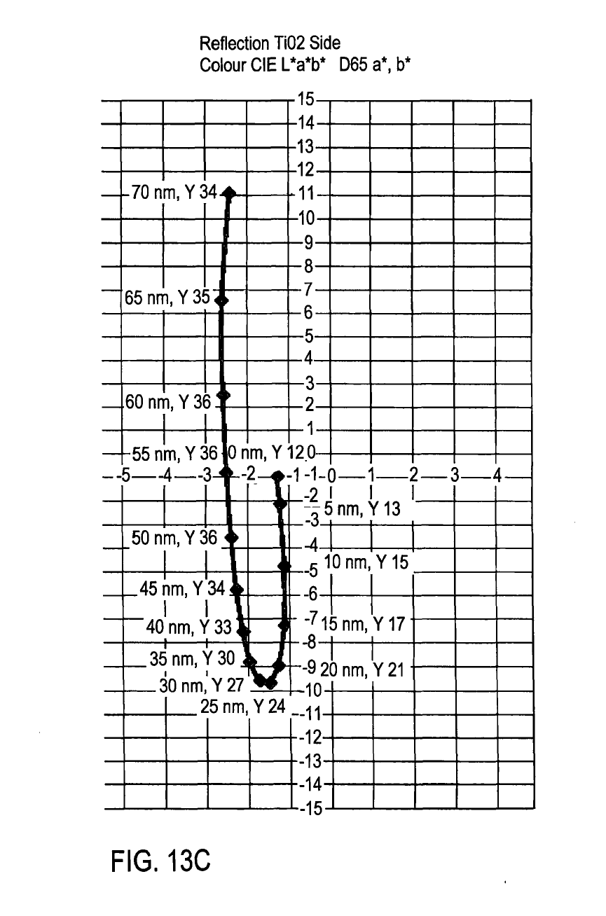

FIG. 13 shows visible colour attribute curves of the glazing of FIG. 11;

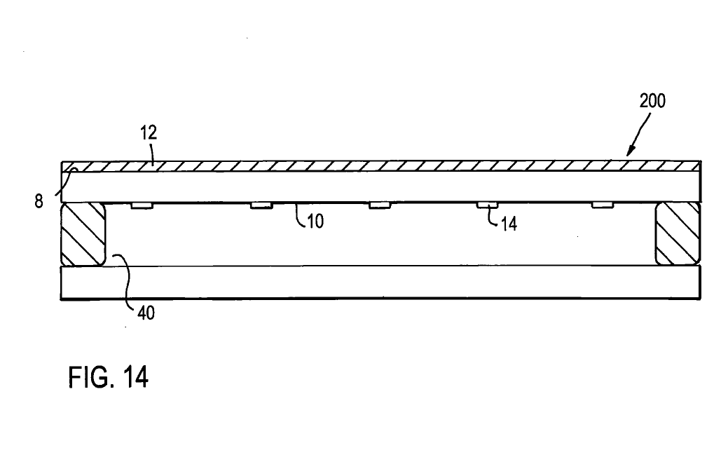

FIG. 14 shows a schematic sectional view of an embodiment of a glazing according to the present invention;

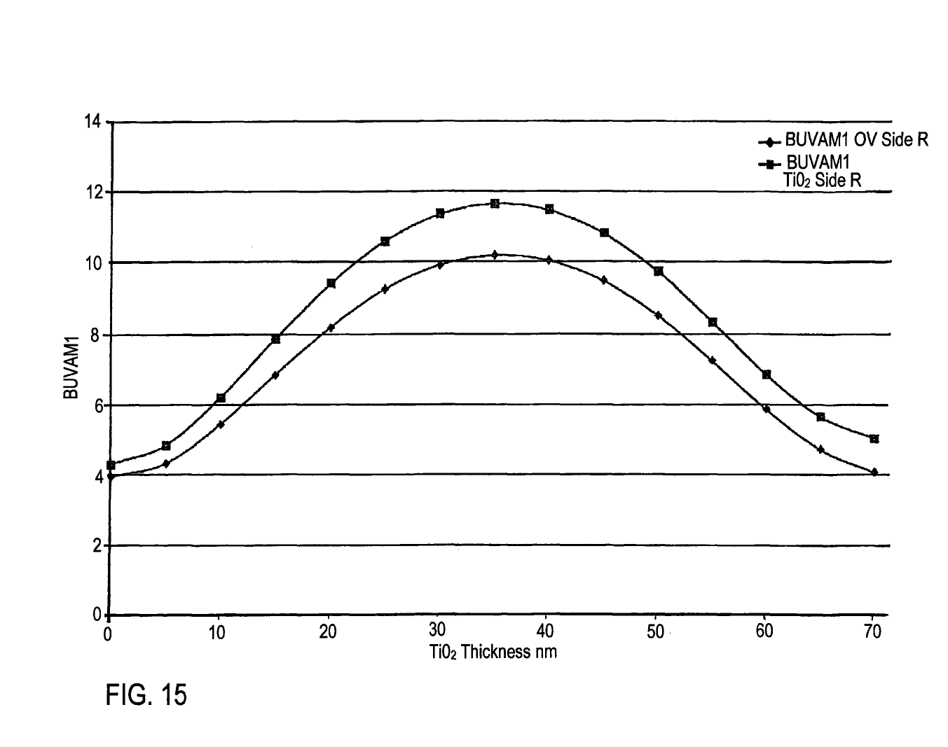

FIG. 15 shows a graph of variation in BUVAM1 with TiO2 thickness in relation to the glazing of FIG. 14;

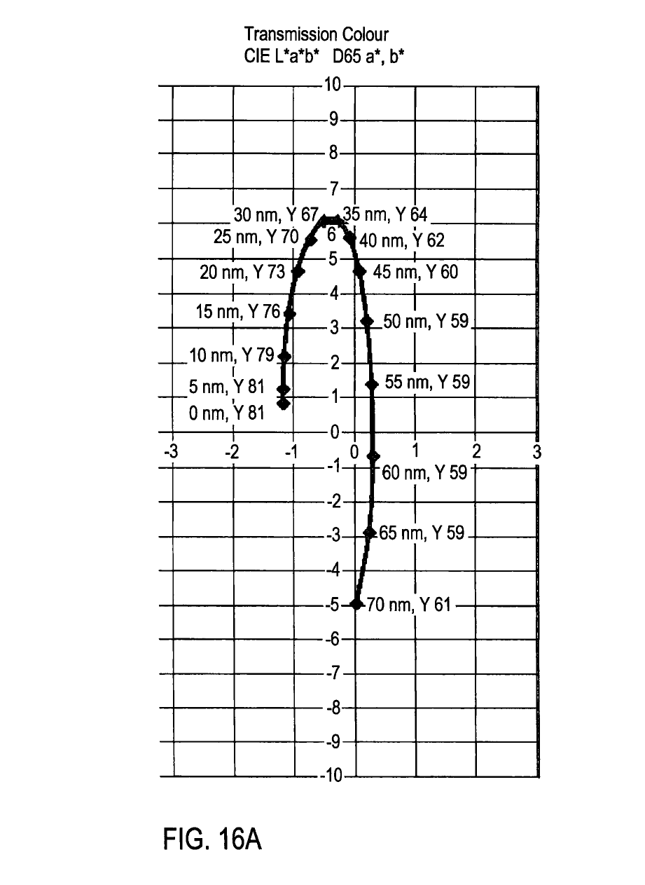

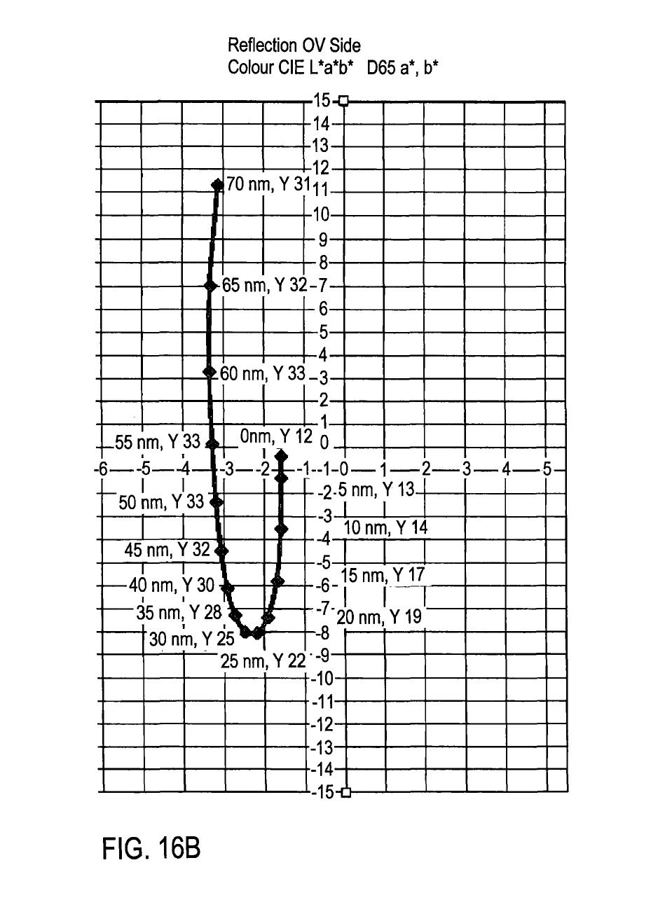

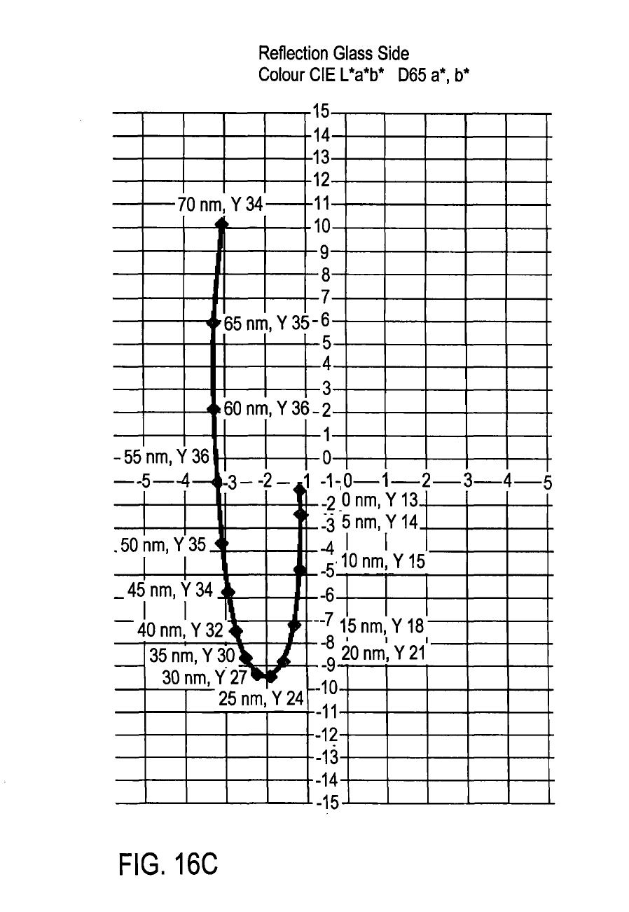

FIG. 16 shows visible colour attribute curves of the glazing of FIG. 14;

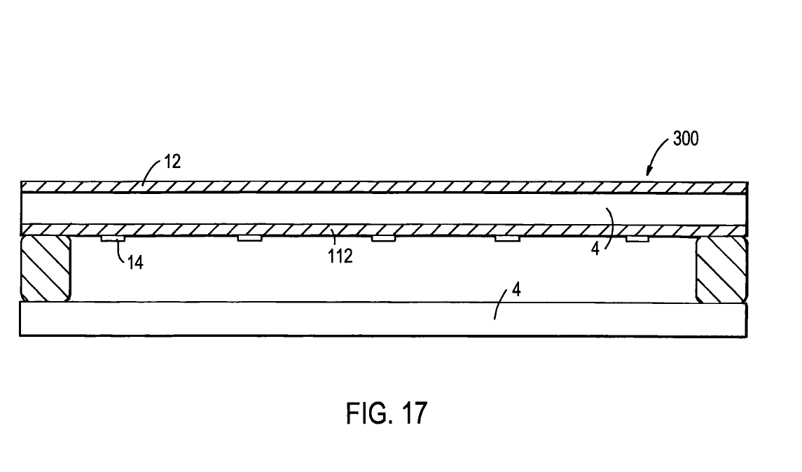

FIG. 17 shows a schematic sectional view of an embodiment of a glazing according to the present invention;

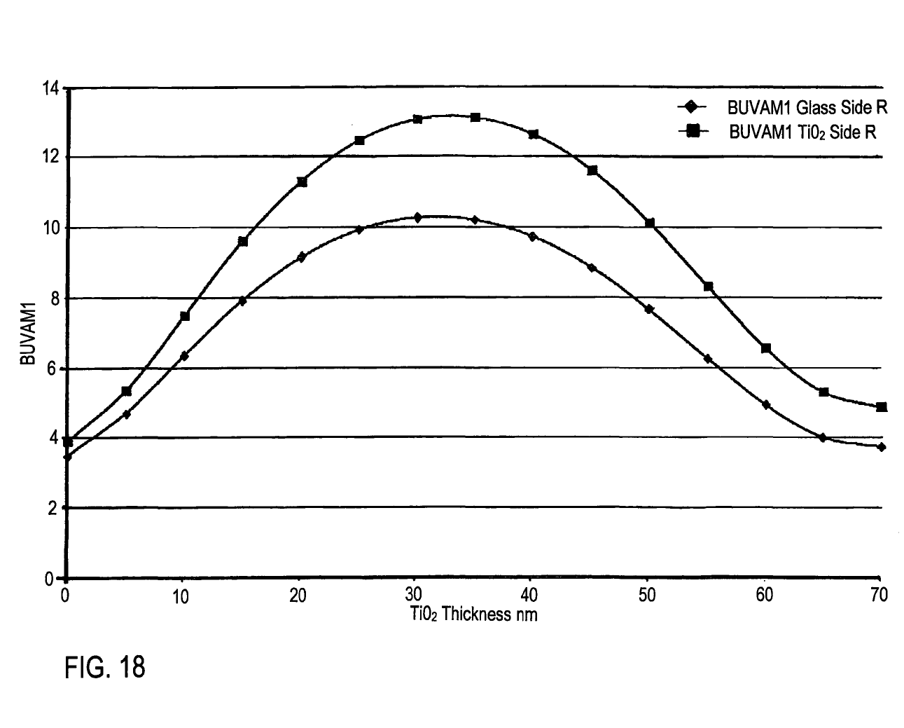

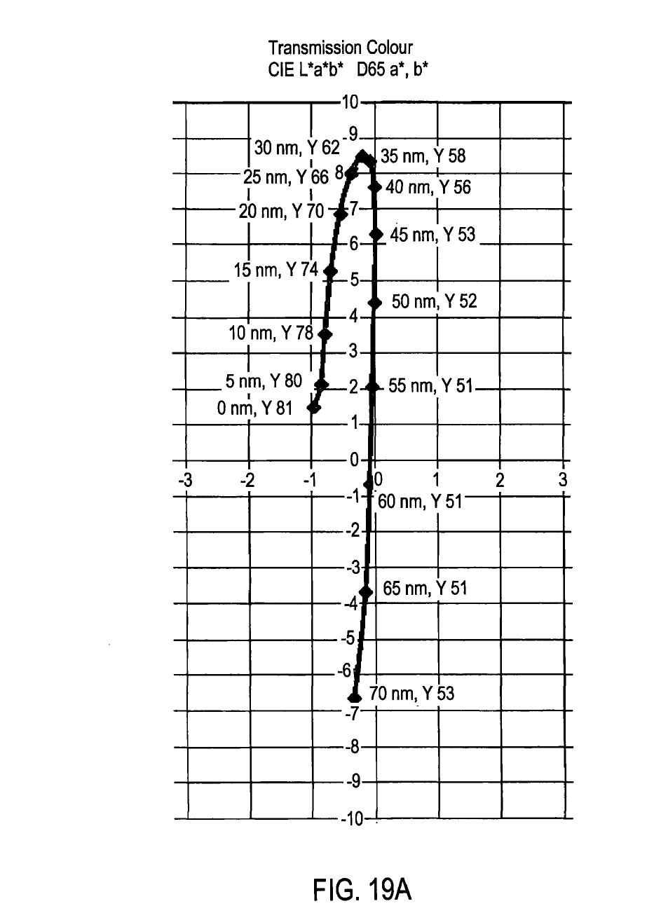

FIG. 18 shows a graph of variation in BUVAM1 with TiO2 thickness in relation to the glazing of FIG. 17;

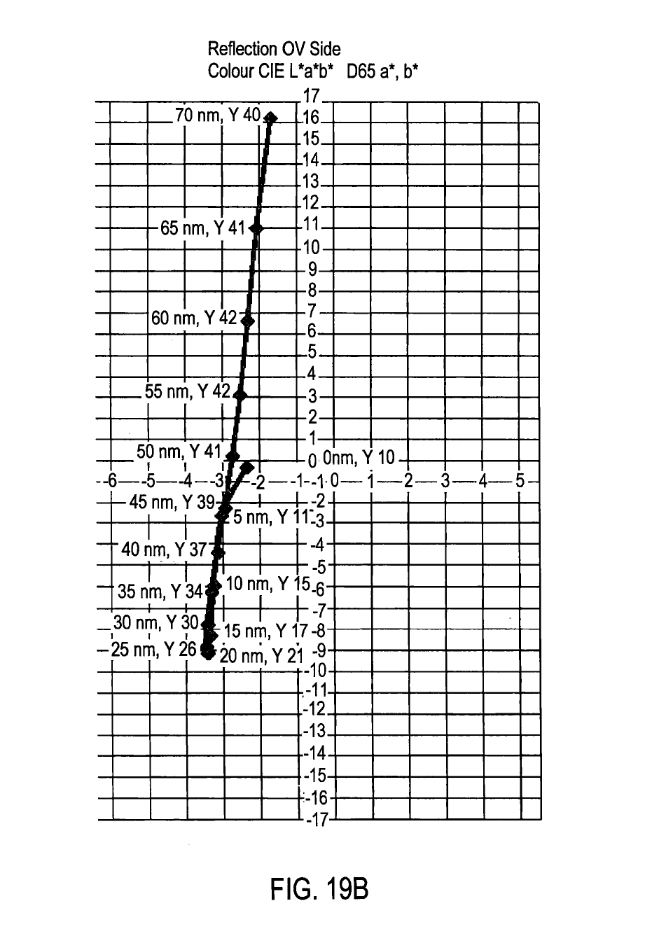

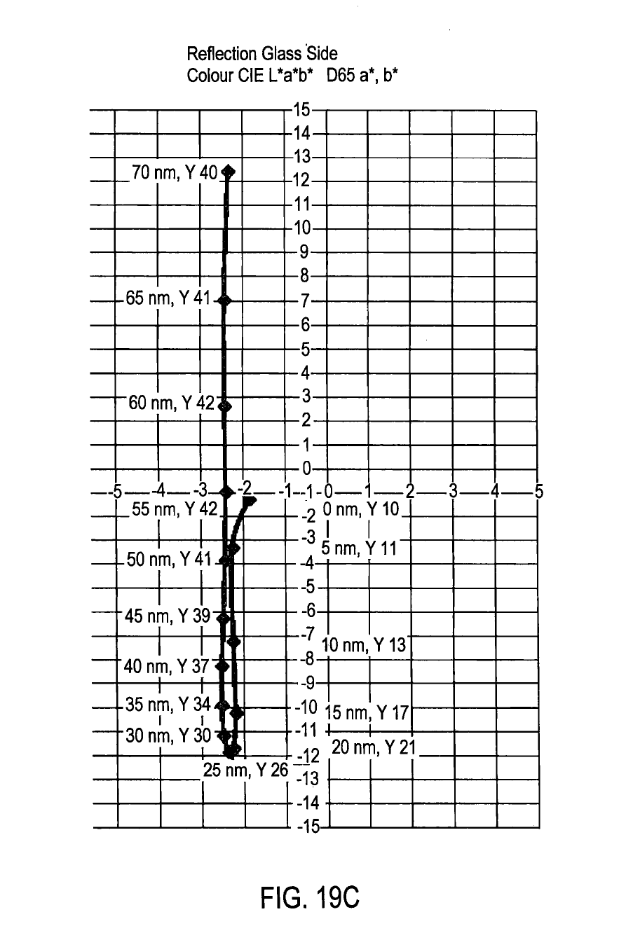

FIG. 19 shows visible colour attribute curves of the glazing of FIG. 17;

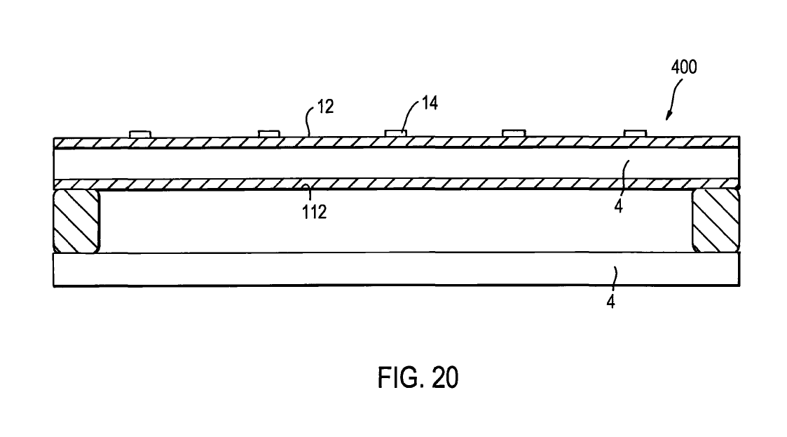

FIG. 20 shows a schematic sectional view of an embodiment of a glazing according to the present invention;

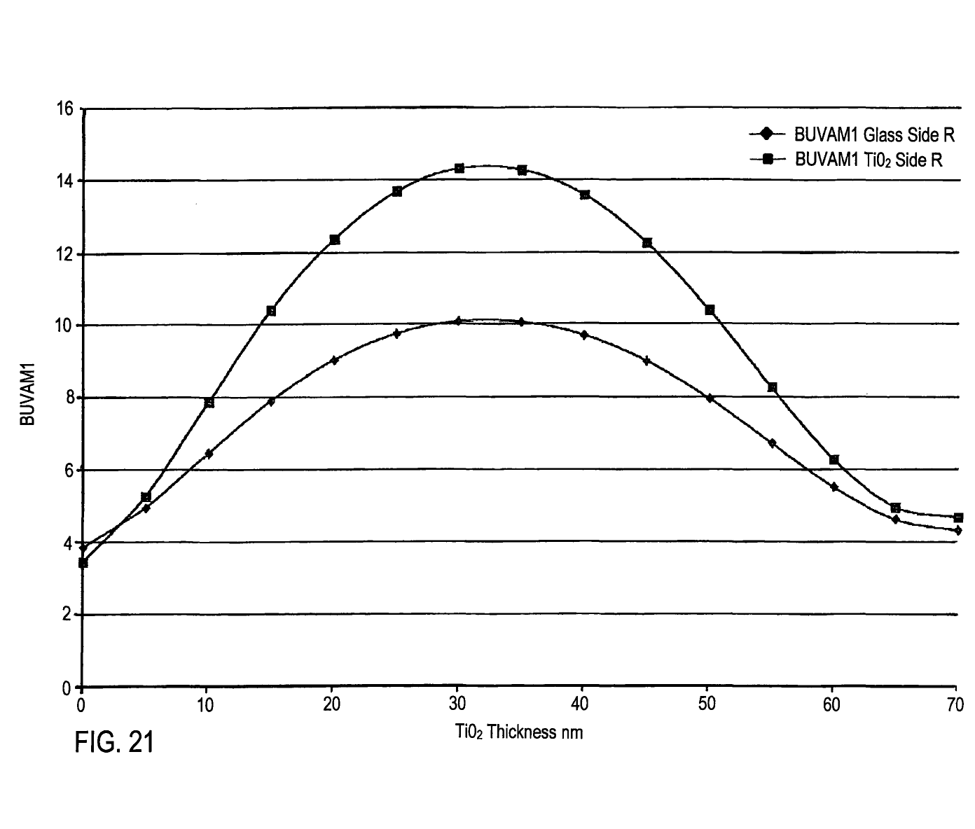

FIG. 21 shows a graph of variation in BUVAM1 with TiO2 thickness in relation to the glazing of FIG. 20;

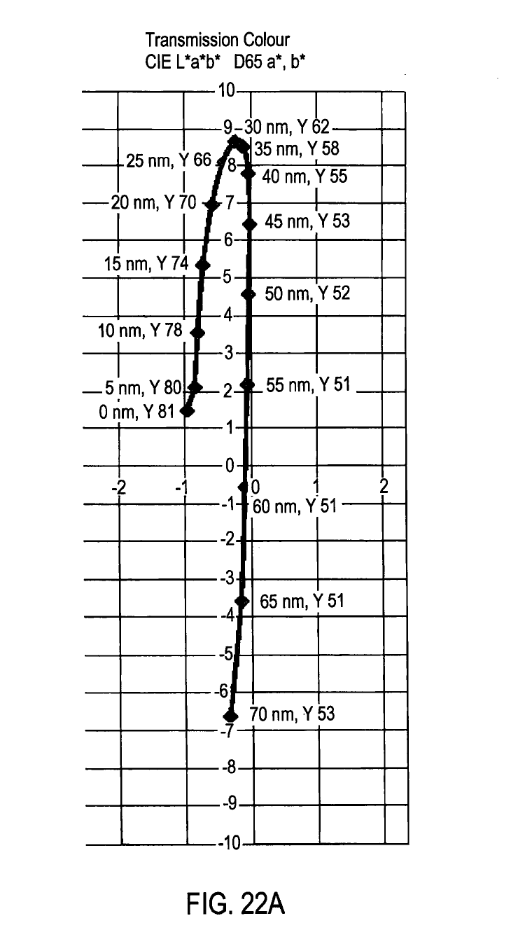

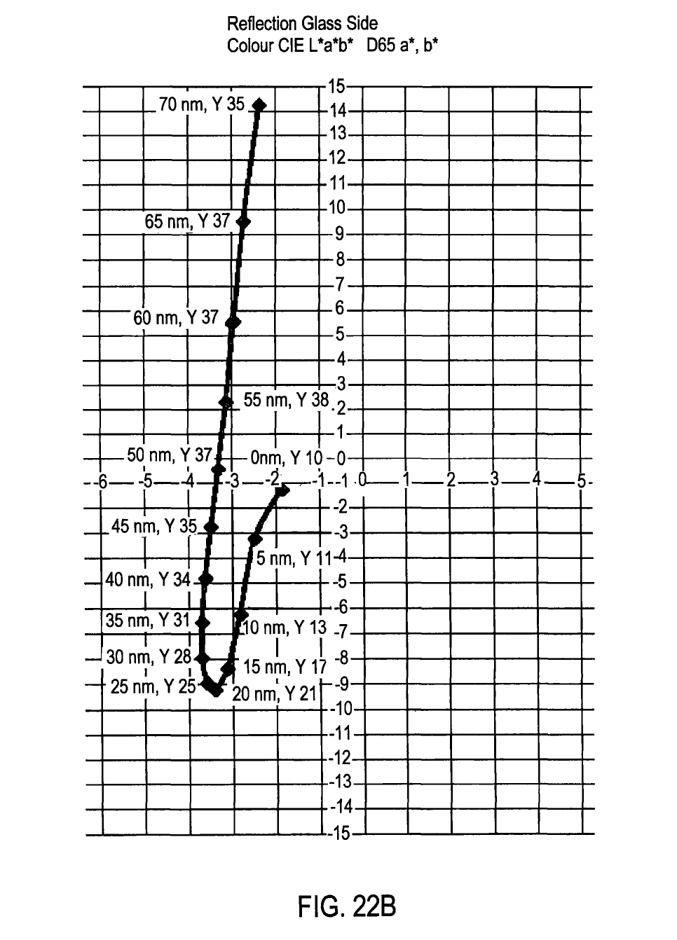

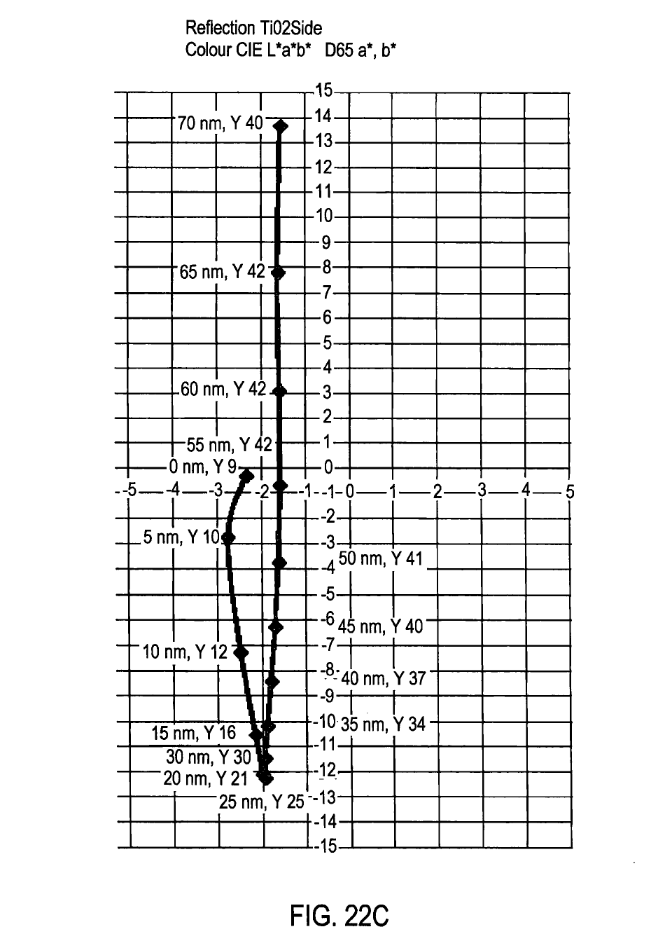

FIG. 22 shows visible colour attribute curves of the glazing of FIG. 20;

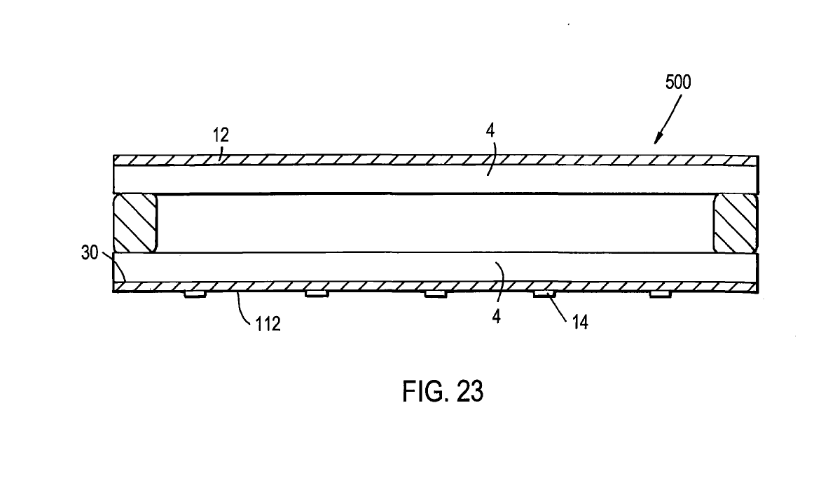

FIG. 23 shows a schematic sectional view of an embodiment of a glazing according to the present invention;

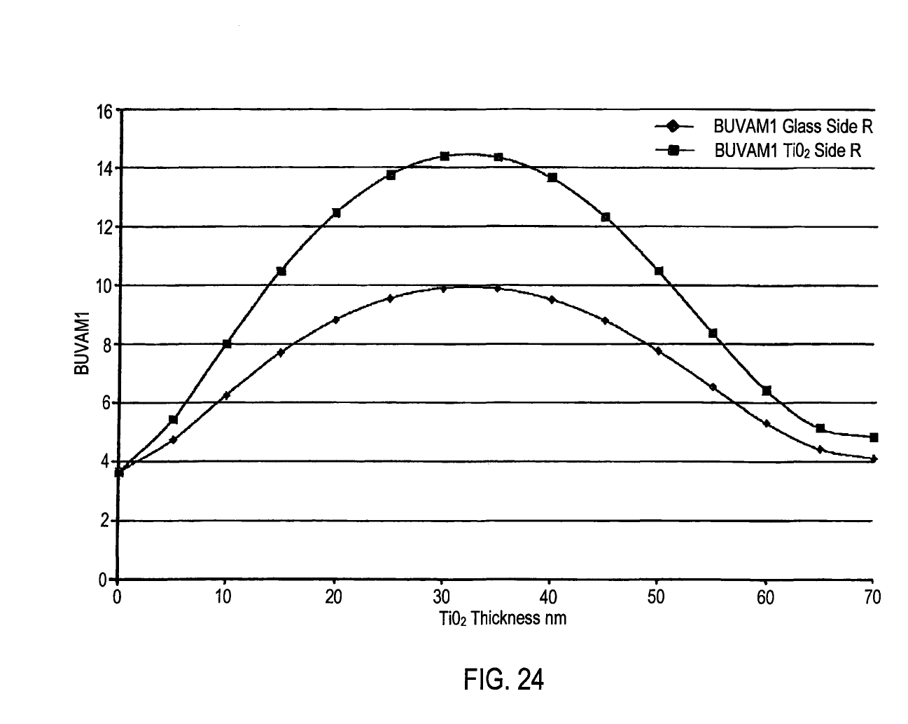

FIG. 24 shows a graph of variation in BUVAM1 with TiO2 thickness in relation to the glazing of FIG. 23;

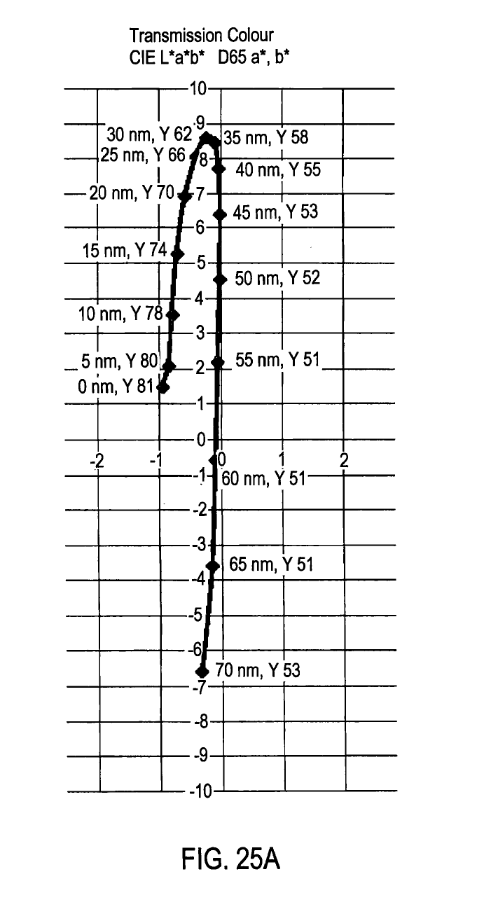

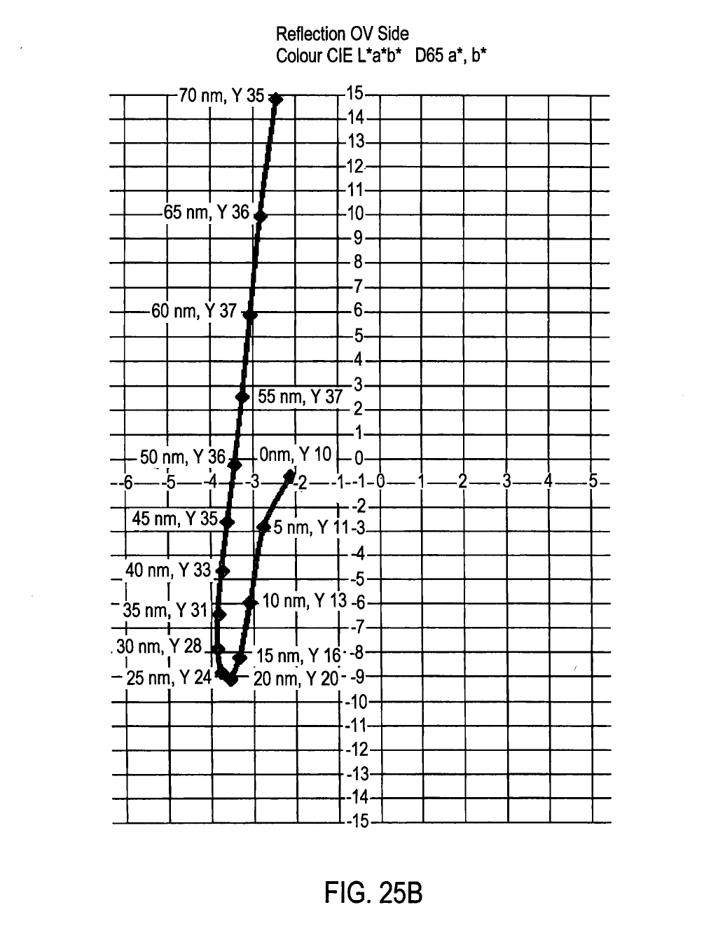

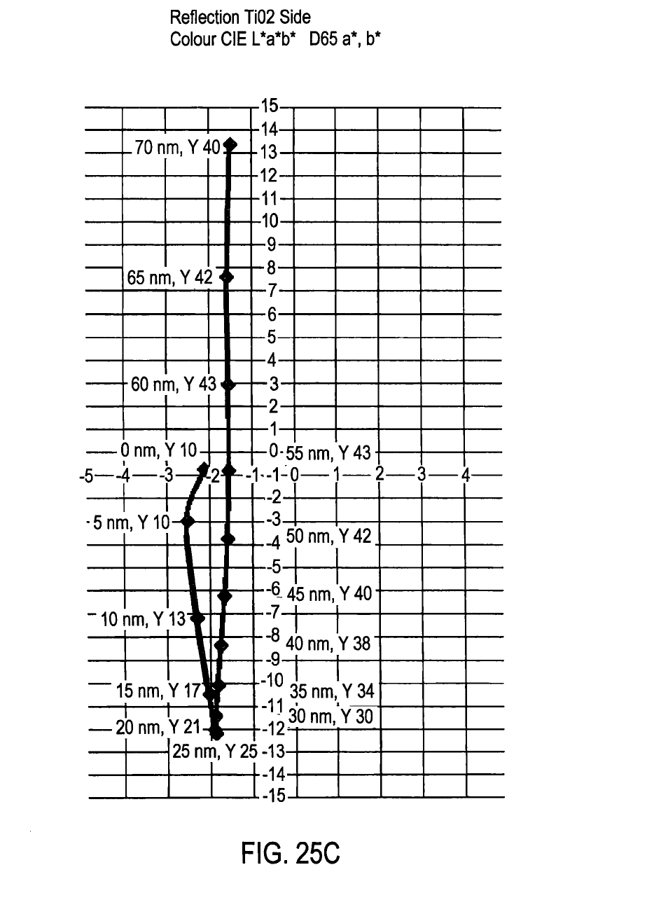

FIG. 25 shows visible colour attribute curves of the glazing of FIG. 23;

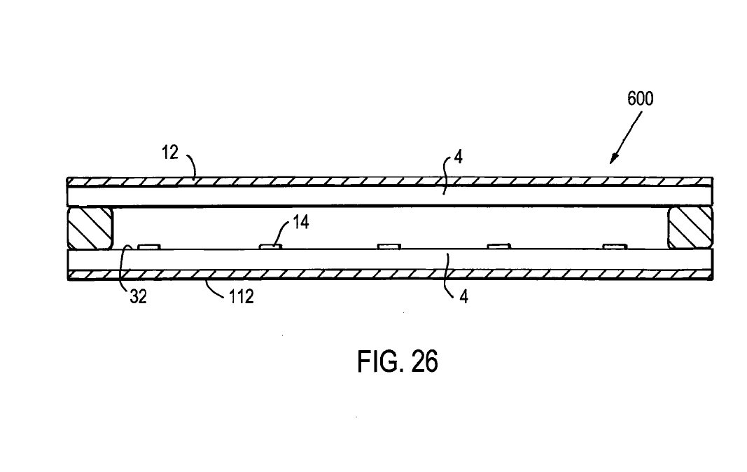

FIG. 26 shows a schematic sectional view of an embodiment of a glazing according to the present invention;

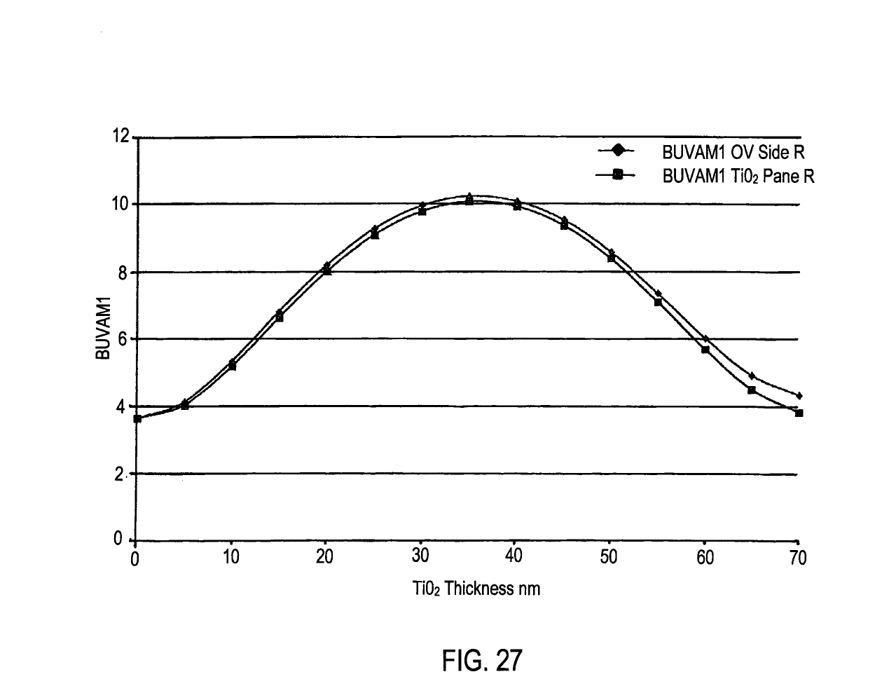

FIG. 27 shows a graph of variation in BUVAM1 with TiO2 thickness in relation to the glazing of FIG. 26;

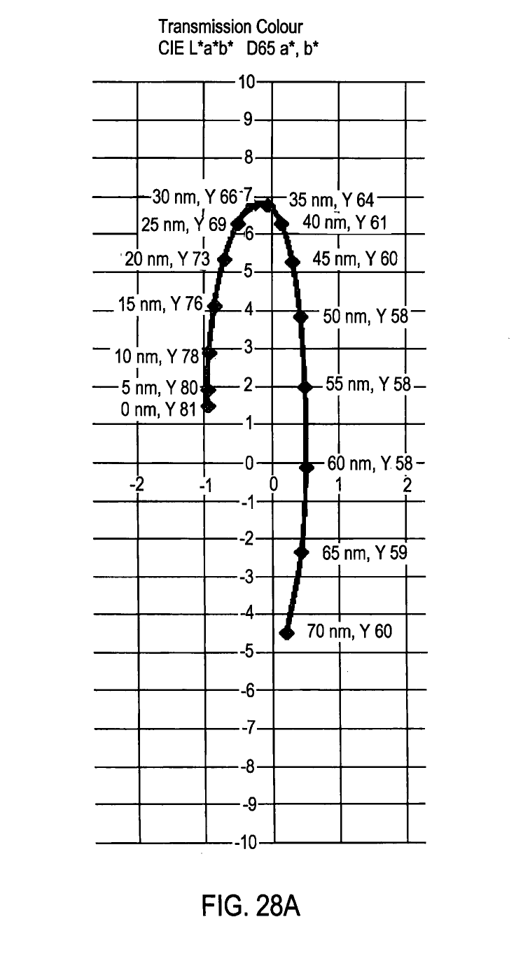

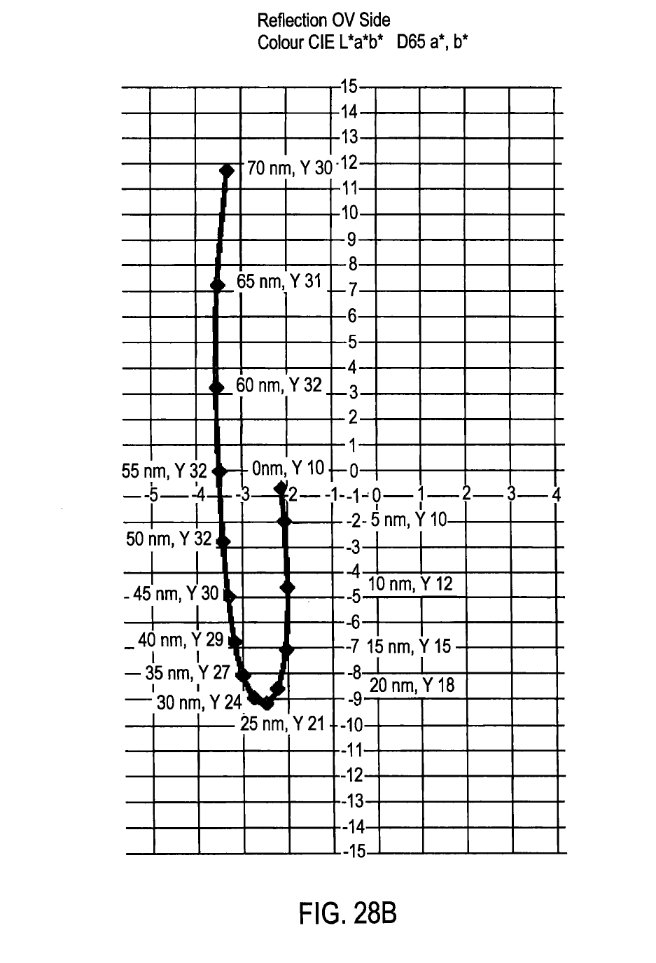

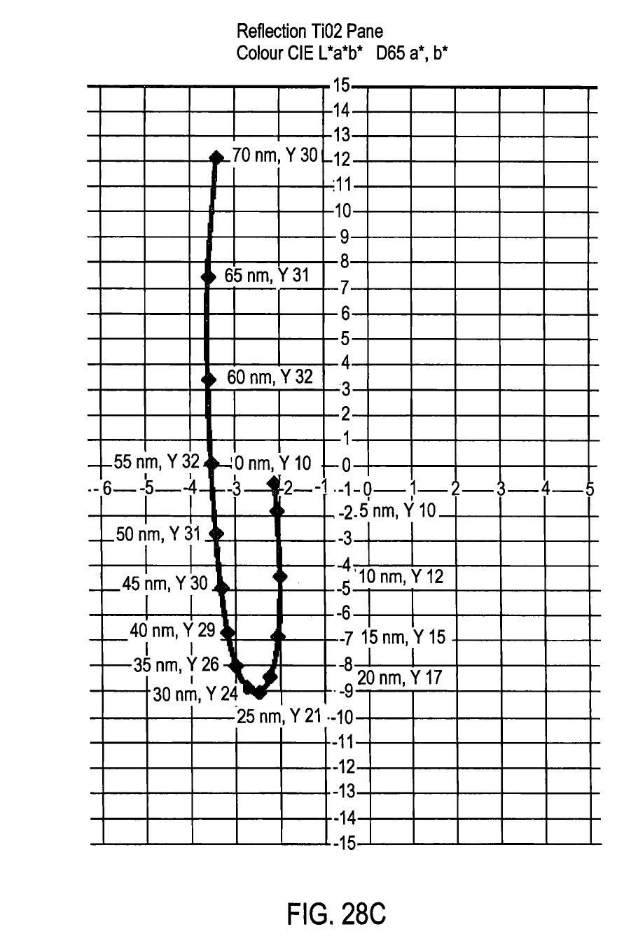

FIG. 28 shows visible colour attribute curves of the glazing of FIG. 26; and

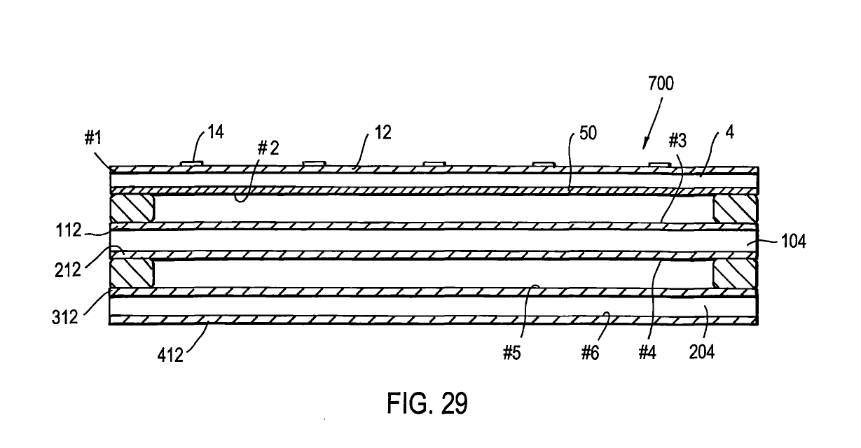

FIG. 29 shows a schematic sectional view of a triple glazed unit of the present invention.

FIG. 1 shows a glazing 2 according to the present invention. The glazing comprises a 4 mm glass substrate 4 of float glass having a first surface 8 and a second surface 10. The first surface 8 is that surface of the glazing which faces the exterior of a building when mounted in use, often referred to as “surface #1” of the glazing. An antireflection coating 12 (shown by hatched lines) is provided directly on to the first surface 8, and a UV reflectance coating 14 is provided on top of the antireflection coating 12 in a patterned arrangement comprising a number of separate elements 14.

The antireflection coating 12 was deposited on to the substrate 4 using chemical vapour deposition in the float bath region of a float furnace, a process as described in WO97/42357A1 and hereby incorporated. Said coating 12 consists of a plurality of layers as shown in FIG. 2, comprising: a first layer 16 of SnO₂ having a geometric thickness of approximately 12 nm; a second layer 18 of SiO₂ having a geometric thickness of approximately 25 nm deposited over the first layer 16; a third layer 20 of F:SnO₂ having a geometric thickness of approximately 110 nm deposited over the second layer 18; and a fourth layer 22 of SiO₂ having a geometric thickness of approximately 90 nm deposited over the third layer 20. Such a coating is hereinafter also referred to as an Optiview coating.

The UV reflectance coating 14 comprises titanium oxide having a geometric thickness of approximately 31 nm. As shown in FIG. 3, the coating 14 was deposited in a striped pattern directly on top of the antireflection coating 12. Deposition was by sputter coating as will be described in further detail below.

In order to deposit the optimum coating for avian vision, optical modelling simulation was carried out. A basic model of the antireflection coating 12 was made to allow the simulation of different sputtered TiO₂ thicknesses in different constructions. A number of glazing configurations were modelled as shown in the figures. CODE™ optical modelling software was used to produce an effective approximation of the optical response of the antireflection coating 12 as shown in FIG. 4.

### TiO₂ Coating Optimisation

As bird vision is not covered by the usual standard integrated optical values a new integrated value needed to be constructed. This was based on our understanding that bird short-wave UV eye sensitivity peaked at 370 nm with approx±25 nm width at FWHM. The situation is complicated by the fact that the solar curve is decreasing rapidly in intensity in this region. An appropriate combined curve for an integrated value is obtained by multiplying normalised versions of the two together. This curve has been called BUVAM1 and is shown with its parent curves in FIG. 5.

BUVAM1 is a measure of Bird-visible UV energy calculated by convoluting a Gaussian curve, representing Bird UV-cone vision, with the air-mass 1 (AM1) solar energy curve. The Gaussian curve is centred on 370 nm with approx±25 nm width at FWHM. The BUVAM1 curve is integrated against the measured/predicted spectrum for the coating to give an integrated BUVAM1 curve.

The BUVAM1 curve can be used as the data source for integration against the model spectral curves within the CODE optical modelling software. It can be used to generate integrated Bird UV figures for different construction embodiments, and to optimise those constructions for performance and colour.

The BUVAM1 reflectance of a single glazed construction as shown in FIG. 1 was calculated from either side of the construction for varying TiO₂ thickness. The data shown in FIG. 6 allows optimisation for BUVAM1 reflectance. It is clear that having the TiO₂ coating on the external surface (surface #1) as represented by the “blocks” line referenced in FIG. 6 as “BUVAM1 TiO2 Side R” gives the best UV reflectance for a given TiO₂ thickness. The maximum reflectance is achieved at around 35 nm with the TiO₂ side reflectance being about six times that of the non UV coated glass. FIG. 7 shows the visible colour attributes of single glazed TiO2 pattern coated directly on to an antireflective coating (Optiview coating) on a glass substrate.

FIG. 8 shows an embodiment of a single glazed construction in which the UV reflectance coating 14 is deposited directly on to surface #1 of the glass substrate 4 and the antireflection coating 12 is deposited on to surface #2 of the substrate. FIGS. 9 and 10 again show the advantages of having the TiO2 on the external surface.

The same calculation of BUVAM1 was carried out for a Double Glazed Unit (DGU) 100 with TiO₂ coating on an external surface (surface #1) as shown in FIG. 11. An antireflection coating 12 is deposited on surface #2 (10). FIGS. 11 & 12 can be compared with FIGS. 8 & 9 respectively (single glazing case) which show that the maximum falls are in the same location and the curve has the same shape, but shifted upwards slightly. The curves diverge to a greater degree due to the DGU construction. The important feature is the glass reflectance at 0 nm TiO₂. This is nearly double the single glazed case and means the contrast ratio between UV coated stripes and non UV coated glass will be roughly halved. FIG. 13 shows that colours are slightly muted by the internal clear glass. The transmission redness is reduced slightly with a small decrease in yellowness of transmission and blueness of reflection.

FIG. 14 shows an alternative embodiment of the invention wherein a DGU 200 has the antireflection coating 12 on surface #1 of the glazing and a UV reflective coating 14 on a surface 10 facing a space 40 (surface #2) of the unit. FIG. 15 can be compared with FIG. 9 (single glazing case) and FIG. 12 (double glazing with TiO₂ on surface #1). It is clear from FIG. 15 that it is better to have the clear glass pane as the outside ply than to have the antireflection coating on surface#1. This is an advantageous arrangement for this double glazing option as the sputtered coating is kept inside the DGU and is therefore less prone to damage. The visible colour attributes of the arrangement are shown in FIG. 16. There is no significant difference to glazing with TiO₂ on surface #1.

FIG. 17 shows a further alternative embodiment of the invention having a DGU 300 with antireflection coating 12 on surface#1 and a second antireflection coating 112 on surface#2 of the first ply. A UV reflective coating 14 is deposited over the coating 112 on surface #2 in a striped arrangement. Model calculations are shown in FIGS. 18 and 19. Surprisingly, the contrast ratio is not improved significantly by the inclusion of the extra antireflection layer 12 on the external surface. However this contrast ratio is only based on the difference in Bird UV reflectance. The visible reflectance is decreased and this would reduce the overall reflectance in the glass areas that have no TiO₂ patterning. This design gives far stronger yellow transmission colour and bluer reflection.

FIG. 20 shows a further embodiment of the invention having a DGU 400 having antireflection coating 12 on surface #1 and a second antireflection coating 112 on surface #2, and a UV reflective coating 14 deposited on top of the coating 12 on surface #1. As shown in FIG. 21, this configuration produces higher outright BUVAM1 and higher contrast ratio than that with TiO₂ on the internal surface. FIG. 22 shows that the colours remain moderately yellow/blue.

FIG. 23 shows a further embodiment of the invention having a DGU 500 having antireflection coating 12 on surface #1 and a second antireflection coating 112 on surface #4 (30) of the unit. A UV reflective coating 14 is deposited on top of coating 112 on surface #4. This would be a simpler configuration for glazings with two antireflection coatings, rather than adding a reverse coating to a coated pane. Further, coating the antireflection coating directly ensures for minimal issues with back surface damage and the antireflection effect is destroyed locally. Other performance is similar as shown in FIGS. 24 and 25.

FIG. 26 shows a further alternative embodiment of the invention wherein a DGU 600 comprises an antireflective coating 12 on surface #1 and a second antireflection coating 112 on surface #4. A UV reflection coating 14 is deposited on an inner surface 32 of the second ply known as surface #3. Advantageously, this construction is easier to manufacture and has the benefit of improved colour as shown in FIG. 28; this must be balanced with low BUVAM1 values and low contrast.

FIG. 29 shows an embodiment of a triple glazed unit 700. The unit 700 comprises a first sheet of glazing material 4, a second sheet of glazing material 104, and a third sheet of glazing material 204. An antireflection coating 12, 112, 212, 312 and 412 is provided on surfaces #1, #3, #4, #5 and #6 of said sheets as shown in the figure. A UV reflection coating 14 is provided on top of the antireflection coating 12, in a striped arrangement. A solar control coating 50 is provided on surface #2. A low-E coating may in addition be deposited on surface #2, and/or surface #5, and/or surface #6.

The results are tabulated below in Table 1 which shows a 15 nm TiO₂ coating, and Table 2 which shows a 35 nm TiO₂ coating. The measured values are detailed further below.

Contrast Ratio is the ratio of BUVAM1 for a TiO₂ stripe to BUVAM1 for the uncoated Optiview. This is for external reflection unless stated otherwise.

$$i . e . Contrast Ratio = \frac{BUVAM 1 TiO 2 Stripe}{BUVAM 1 Optiview}$$

Rᵥᵢₛ/BUVAM1 is a ratio which shows how the total energy reflected, for example in one stripe, is skewed away from the bird-visible UV. A smaller figure is better for the UV-reflecting stripes.

TABLE 1
Summary of integrated properties for 15 nm TiO₂

| | | | Contrast | | | | |
|---|---|---|---|---|---|---|---|
| FIG. | Construction | BUVAM1 | Ratio | Rᵥᵢₛ | T b* | R b* | Rvis/BUVAM1 |
| FIG. 1 | 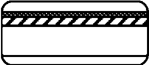 | 9.7 | 4.4 | 12.8 | 4.9 | −12.8 | 1.3 |
| | 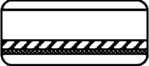 | 8.1 | 3.5 | 13.2 | 4.9 | −11.7 | 1.6 |
| FIG. 8 | 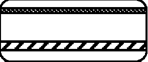 | 7.3 | 3.2 | 11.5 | 3.7 | −10.4 | 1.6 |
| | 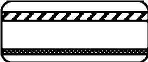 | 5.7 | 2.6 | 10.6 | 3.7 | −8.8 | 1.9 |
| FIG. 11 | 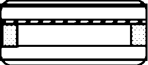 | 8.5 | 2.1 | 17.5 | 3.5 | −7.2 | 2.1 |
| | 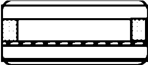 | 6.8 | 1.6 | 17.3 | 3.5 | −5.9 | 2.5 |
| FIG. 14 | 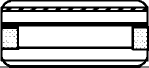 | 6.8 | 1.7 | 16.7 | 3.5 | −5.8 | 2.5 |
| | 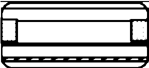 | 7.9 | 1.8 | 17.9 | 3.5 | −7.1 | 2.3 |
| FIG. 17 | 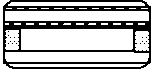 | 7.9 | 2.3 | 15.8 | 5.3 | −8.2 | 2.0 |
| | 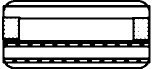 | 9.6 | 2.5 | 17.0 | 5.3 | −10.2 | 1.8 |
| FIG. 20 | 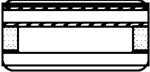 | 10.4 | 3.0 | 16.0 | 5.4 | −10.5 | 1.5 |
| | 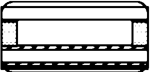 | 7.9 | 2.0 | 16.8 | 5.4 | −8.3 | 2.1 |
| FIG. 23 | 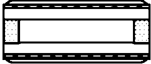 | 7.7 | 2.1 | 16.1 | 5.3 | −8.2 | 2.1 |
| | 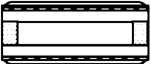 | 10.5 | 2.9 | 16.5 | 5.3 | −10.4 | 1.6 |
| FIG. 26 | 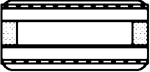 | 6.8 | 1.9 | 14.7 | 4.1 | −7.0 | 2.2 |
| | 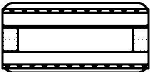 | 6.6 | 1.8 | 14.5 | 4.1 | −6.8 | 2.2 |

TABLE 2
Summary of integrated properties for 35 nm TiO₂

| | | | Contrast | | | | |
|---|---|---|---|---|---|---|---|
| FIG. | Construction | BUVAM1 | Ratio | Rᵥᵢₛ | T b* | R b* | Rvis/BUVAM1 |
| FIG. 1 | 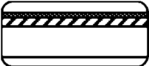 | 13.9 | 6.3 | 32.0 | 8.3 | −11.1 | 2.3 |
| | 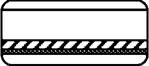 | 11.0 | 4.7 | 30.9 | 8.3 | 32.0 | 2.8 |
| FIG. 8 | 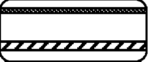 | 12.2 | 5.3 | 25.9 | 6.6 | −10.6 | 2.1 |
| | 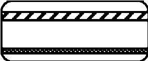 | 9.5 | 4.3 | 23.6 | 6.6 | 25.9 | 2.5 |
| FIG. 11 | 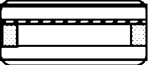 | 12.9 | 3.2 | 30.1 | 6.2 | −8.8 | 2.3 |
| | 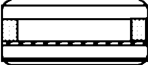 | 9.8 | 2.4 | 28.1 | 6.2 | 30.1 | 2.9 |
| FIG. 14 | 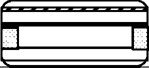 | 10.2 | 2.6 | 27.8 | 6.1 | 30.1 | 2.7 |
| | 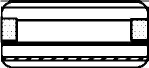 | 11.6 | 2.7 | 30.1 | 6.1 | −8.6 | 2.6 |
| FIG. 17 | 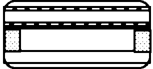 | 10.2 | 3.0 | 30.9 | 8.4 | 34.0 | 3.0 |
| | 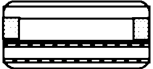 | 13.1 | 3.4 | 34.0 | 8.4 | −9.9 | 2.6 |
| FIG. 20 | 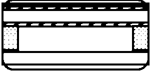 | 14.3 | 4.1 | 33.9 | 8.6 | −10.1 | 2.4 |
| | 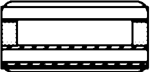 | 10.1 | 2.6 | 31.4 | 8.6 | 33.9 | 3.1 |
| FIG. 23 | 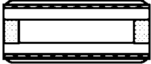 | 9.9 | 2.7 | 30.7 | 8.5 | 34.3 | 3.1 |
| | 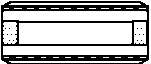 | 14.4 | 3.9 | 34.3 | 8.5 | −10.1 | 2.4 |
| FIG. 26 | 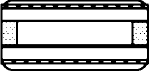 | 10.2 | 2.8 | 26.5 | 6.8 | 26.3 | 2.6 |
| | 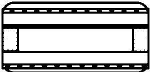 | 10.1 | 2.7 | 26.3 | 6.8 | −8.0 | 2.6 |

The results show that the single glazed panes give the optimum performance with the arrangement of FIG. 1 being particularly good. In relation to the DGU arrangements, the highest performance option is shown by the arrangement of FIG. 20. Advantageously, best performance is obtained when the TiO₂ coating (the UV reflective coating) is deposited directly on the antireflection coating 12 i.e. glass substrate with Optiview coating as shown in FIG. 2.

Both the 15 nm and 35 nm TiO₂ thicknesses show the same pattern in relation to construction design but the performance is far better for 35 nm embodiments. This is at the expense of colour which, for transmission b* moves from 5.3 to 8.5 when moving from 15 to 35 nm. Experimental samples were constructed to demonstrate the modelling data as detailed below. From the modelling data, the optimum design for maximum avian visibility comprises a striped pattern of 35 nm of titania directly coated onto an antireflective coating (Optiview) coated substrate. For ease of manufacturing the titania pattern was deposited by shadow masking sputtered titania.

### Experimental Samples

Demonstrator samples of 4 mm substrate were made in two sizes, 650 mm wide×1000 mm high and 500 mm wide×1000 mm high. The pattern was 25 mm wide TiO₂ stripes at 100 mm pitch (i.e. 75 mm wide OptiView stripes were between each pair of TiO₂ stripes as shown schematically in FIG. 3). The pattern was a regular repeating pattern. Optical modelling of the deposited coating showed that the TiO₂ film was 31 nm thick and provided better than expected enhancement of bird-UV visible contrast in the pattern (Contrast Ratio of 9). The additional improvement came from lower than predicted UV reflectance in the Optiview substrate. This shows that control of the Optiview design to minimise UV reflectance is vital to maximise UV contrast.

The coating could theoretically be deposited in any number of coating techniques including, but not limited to, chemical vapour deposition, sputtering, sol-gel coating, evaporation, electroplating/oxidation, plasma-enhanced CVD, atomic layer deposition, pulsed laser deposition and various printing techniques. However for this particular experimental work, reactive magnetron sputtering was used.

### Coating Work—Experimental

4 mm float glass substrate was coated with an antireflective coating; the substrate stack comprising glass/12 nm SnO₂/25 nm SiO₂/110 nm F:SnO₂/90 SiO₂ (Optiview). Shadow masks were made from thin glass cut to 75 mm width and attached with vacuum compatible adhesive tape. The titania was deposited using pure Ti metal targets in plasma emission monitor-controlled oxygen reactive sputtering. The process conditions are shown in Table 3.

TABLE 3
TiO₂ deposition parameters

| Layer | Material | Process Parameters |
|---|---|---|
| 1 | Ti | 35 kW 100 kHz MF, Speed 466 mm/min (5 passes), Ar |
| | | 250 sccm, 13% PEM setpoint for Ti emission, con- |
| | | trolling O2 flow (giving 62-73 sccm) |

Although the nominal coating thickness was 35 nm the actual deposited thickness was calculated by optical modelling of a single layer on a clear float glass substrate coated at the same time as the Optiview. This gave a good fit at 31 nm thickness. Even though this is less than the target of 35 nm the effect on the Bird-UV reflectance is minimal.

### Results

Since all coating runs had the same deposition conditions, the optical measurements for one sample are considered. Spectrophotometer measurements were made between 350 and 1100 nm using a Hunterlab Ultrascan Pro. This range does not fully cover the BUVAM1 curve as it excludes roughly 11% of the energy. However, a person skilled in the art would appreciate that this is sufficient to provide an approximation of whether the coating performance is as expected and both the model data and experimental data are cut-off below 350 nm for the comparison. Table 4 lists the integrated values for the measured data and compares them to those expected for a for a 31 nm TiO₂ layer on the same Optiview stack substrate and the target 35 nm design on the higher UV-reflectance substrate. Samples were made in 3 coater runs.

TABLE 4
Comparison of target, predicted and measured
performance for 31 nm TiO₂ on Optiview

| | Target 35 nm | Model 31 nm | Measured 31 nm |
|---|---|---|---|
| Parameter | Glass/OV/TiO2 | Glass/OV/TiO₂ | Glass/OV/TiO₂ |
| Rₑₓₜₑᵣₙₐₗ BUVAM1 | 13.9 | 14.9 | 13.4 |
| (350 nm cut-off) | | | |
| Contrast Ratio | 6.3 | 10.0 | 8.9 |
| Rᵥᵢₛ | 32 | 29.4 | 30.0 |
| T b* | 8.3 | 8.9 | 8.4 |
| Rₑₓₜₑᵣₙₐₗ b* | −11.1 | −13 | −8.7 |
| Rᵥᵢₛ/BUVAM1 | 2.3 | 2.0 | 2.2 |
| Optiview ™ | 2.2 | 1.49 | 1.49 |
| BUVAM1 | | | |

Rᵥᵢₛ/BUVAM1 is a ratio which shows how the total energy reflected, for example in one stripe, is skewed away from the bird-visible UV. A smaller figure is better for the UV-reflecting stripes. For the examples above, this ranges between 2 to 2.3. That means the stripes reflect twice as much “non-UV” light compared with UV. For the contrasting Optiview substrate it would be advantageous to have this ratio as large as possible. For the experimental Optiview sample without TiO₂ this is about 3.5.

The results shows that experimental data closely follows prediction with the exception of transmission b*, which is strongly affected by small errors at the blue end of the visible spectrum. The measured values were similar to the original 35 nm prediction on the higher-UV-reflecting Optiview, but that difference in substrate UV reflectance makes a marked difference in the calculated Contrast Ratio, which uses it as a denominator. Control of the UV reflectance design between 330 and 430 nm is an important factor in maximising BUVAM1 differences between the Optiview and TiO₂ stripes.

Advantageously, the results show that bird-UV contrast between TiO₂ coated areas and their uncoated surroundings can be significantly enhanced by adding preferably TiO₂ substantially 35 nm thick and choosing the correct glazing construction. Best performance is obtained by coating TiO₂ over an Optiview coating on surface #1 (as shown in FIG. 1). This is further enhanced by a second such antireflective coating on the reverse surface of the same pane or on the further pane in the DGU.

The patterned multilayer coatings have been developed with enhanced contrast for avian vision. The invention provides a combination of glass substrates with broadband antireflection coatings and enhanced UV reflection coatings. The coatings may be combined in different sequences and thicknesses to get a range of enhanced UV contrast effects. In some embodiments the UV reflective coating is used to destroy the anti-reflective performance of the AR coating while still enhancing UV reflectance to even further maximise the pattern contrast.

Further advantageously, the reflective TiO₂ not only provides enhanced UV reflectance, but also destroys the antireflective effect of the Optiview coating at the stripe location. This gives a dual enhancement of the UV pattern. Consequently, birds readily see the contrasting pattern and so the risk of bird collision with the glazing is minimised.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-20. (canceled)

21. A glazing for minimising or preventing bird collisions with windows or other glazings, the glazing comprising at least one substrate, an antireflection coating, and a UV reflectance coating, the antireflection coating being between the UV reflectance coating and the substrate, wherein the UV reflectance coating is provided in a patterned arrangement comprising a plurality of separate elements, each element being spaced apart from a neighbouring element.

22. The glazing as claimed in claim 21, wherein the patterned arrangement has at least one line of symmetry.

23. The glazing as claimed in claim 21, wherein the patterned arrangement comprises a plurality of stripes.

24. The glazing as claimed in claim 23, wherein said stripes are equidistantly spaced apart from one another.

25. The glazing as claimed in claim 23, wherein a plurality of substantially 2.5 cm wide UV reflecting stripes of said reflectance coating are provided, each said stripe being separated by a substantially 7.5 cm antireflection coating stripe.

26. The glazing as claimed in claim 21, wherein the antireflection coating is provided adjacent the substrate.

27. The glazing as claimed in claim 21, wherein the UV reflectance coating is deposited on an exterior facing surface of the substrate.

28. The glazing as claimed in claim 21, wherein the antireflection coating is provided on a surface #1 of the substrate, and a plurality of patterned areas of UV reflectance coating are provided directly on top of said antireflection coating.

29. A glazing for minimising or preventing bird collisions with windows or other glazings, the glazing comprising at least one substrate, an antireflection coating, and a UV reflectance coating, wherein the UV reflectance coating is provided in a patterned arrangement comprising a plurality of separate elements, and the antireflection coating is provided on a different surface of the substrate to that on which the UV reflectance coating is provided.

30. An insulated glazing unit for minimising or preventing bird collisions with windows or other glazings, comprising a first sheet of glazing material, a second sheet of glazing material, at least one antireflection coating, and at least one UV reflectance coating, wherein the UV reflectance coating is provided in a patterned arrangement comprising a plurality of separate elements, and said antireflection coating is between said UV reflectance coating and either the first and/or second sheet of glazing material.

31. The insulated glazing unit as claimed in claim 30, wherein the antireflection coating is provided on a surface #1 of the unit and a second antireflection coating is provided on a surface #4, wherein the UV reflectance coating is provided on top of the antireflection coating on surface #1.

32. An insulated glazing unit for minimising or preventing bird collisions with windows or other glazings, comprising a first sheet of glazing material, a second sheet of glazing material, at least one antireflection coating, and at least one UV reflectance coating, wherein the UV reflectance coating is provided in a patterned arrangement comprising a plurality of separate elements, and said antireflection coating is provided on a surface of the first and/or second sheet different to that on which said UV reflectance coating is provided.

33. An insulated glazing unit for minimising or preventing bird collisions with windows or other glazings, comprising a first sheet of glazing material, a second sheet of glazing material, a third sheet of glazing material, at least one antireflection coating, and at least one UV reflectance coating, wherein the UV reflectance coating is provided in a patterned arrangement comprising a plurality of separate elements, and the antireflection coating is between the UV reflectance coating and either the first and/or second sheet, and/or the third sheet of glazing material.

34. The glazing or glazing unit as claimed in claim 21, wherein the UV reflectance coating comprises titanium dioxide having a geometric thickness of between substantially 10-50 nm thick.

35. The glazing as claimed in any claim 21, wherein the or each antireflection coating comprises SnOₓ and/or SiO₂.

36. The glazing as claimed in claim 35, wherein said antireflection coating comprises a plurality of layers, said layers comprising: a first layer comprising tin oxide; a second layer comprising silicon oxide; a third layer comprising fluorine doped tin oxide; and a fourth layer comprising a silicon oxide.

37. The glazing as claimed in claim 36, wherein the UV reflectance coating is provided on the fourth layer of the antireflection coating.

38. The method of manufacturing a glazing for minimising or preventing bird collisions with windows or other glazings; the method comprising the following steps:
a) providing at least one substrate;
b) depositing at least one antireflection coating on a surface of the substrate; and
c) depositing at least one UV reflectance coating in a patterned arrangement, the patterned arrangement comprising a plurality of separate elements, over the or each antireflection coating.

39. The method as claimed in claim 38, wherein step (b) is carried out using a chemical vapour deposition process.
